(19) United States
(12) Patent Application Publication
(10) Pub. No.: US 2026/0034529 A1
(43) Pub. Date: Feb. 5, 2026

(54) GRAPHENE AND HETEROGRAPHENE NANORIBBON AND NANOPLATELET COMPOSITES DERIVED FROM GELS AND AEROGELS

(71) Applicant: Universal Graphene Products LLC, Warminster, PA (US)

(72) Inventors: Gene C. KOCH, Corvallis, OR (US); Matthew P. ALDRED, Greater Manchester (GB)

(21) Appl. No.: 19/080,765

(22) Filed: Mar. 14, 2025

Related U.S. Application Data
(60) Provisional application No. 63/630,955, filed on Mar. 14, 2024.

(51) Int. Cl. B01J 13/00; D01D 5/00; D01F 8/10; D01F 8/18

(52) U.S. Cl. CPC B01J 13/0091; D01D 5/00; D01F 8/10; D01F 8/18

(57) ABSTRACT

An aerogel film may be formed of graphene nanoribbon segments that are crosslinked together at their ends. The graphene nanoribbon segments may include a molecular backbone of aromatic rings or fused aromatic ring systems concatenated together in an approximately linear fashion. The rings or ring systems may be further fused together by bridges of atoms connecting adjacent aromatic rings or fused aromatic ring systems. Each bridge may include only a single atom or two atoms, for example, a sulfur atom, an oxygen atom, or a nitrogen atom, or combinations thereof.

### CROSS-REFERENCE TO RELATED APPLICATION

This application claims the benefit under 35 U.S.C. § 119(e) of the earlier filing date of U.S. Provisional Application No. 63/630,955 filed on Mar. 14, 2024, the disclosure of which is incorporated by reference herein.

### BACKGROUND

Graphene is a form or allotrope of carbon composed of single layers of carbon atoms bonded together in benzene rings that tile together to form a hexagonal lattice (honeycomb) structure 100 consisting completely of aromatic rings (FIG. 1a). The peripheral carbon atoms of this graphene fragment are substituted with hydrogen atoms. (Not shown.) The graphene sheet may be extended in the A and B directions indefinitely. The mineral graphite which consists of millions of layers of graphene stacked to together is currently the commercial source of graphene. Graphene is produced from graphite by treatment with strongly oxidizing reagents that oxidize and break apart the graphene layers producing oxidized fragments of graphene termed graphene oxide. The graphene oxide is then reduced to produce 2-D oligomeric or polymeric fragments of the graphene layers that take the form of platelets or strips of the graphene material. The size and shape of the fragments produced is random and while fractions of the graphene fragments may be roughly separated from each other by molecular weight, the physical and chemical properties of the graphene fragments in the fractions will still vary considerably.

Another issue with graphene produced from graphite is that only the very smallest graphene fragments produced will have any solubility at all in solvents. Solvent suspensions may be produced and then solvent cast onto substrate surfaces, but the films produced will be random in structure.

Computational chemistry has allowed the computer modelling of the properties of discrete graphene fragment structures. The modelling of the mechanical, optical and electronic properties of graphene yield values unobtainable by any other material. These predictions have made the fabrication of devices incorporating graphene a target of high priority research. The tensile strength of graphene is in the range of 130 gigapascals versus 0.76 gigapascals for high strength steel and 4.1 gigapascals for carbon fiber. Graphene is predicted to have a resistivity of 10⁻⁶ ohm·cm as opposed to 1.59×10⁻⁶ ohm·cm for silver. This would make graphene the most conductive material known.

Strips of graphene with widths of less than 100 nm. are called graphene nanoribbons (GNRs). There are two families of GNR structures, those with zigzag edges 110 (FIG. 1b) and those with armchair edges 120 (FIG. 1c). The zigzag GNR materials are predicted to have metallic-like conduction while the armchair GNR material are predicted to be either conducting or semiconducting depending on the nanoribbon width. Both types of nanoribbon may extend to include a very large number of carbon atoms in the A and B directions. The simplest example of a zigzag GNR material is polyacene 200 FIG. 2. This compound is an example of a ladder polymer in which all of the rings of atoms are aromatic. The polymers with n=a large number have never been produced and isolated in a pure form. This is because the conjugated, double-bonded structure is planar rendering the molecules highly inflexible and insoluble. Even oligomeric versions of the polyacene molecules are very difficult to deal with for this reason. For instance, dodecacene (the polyacene formula with n=9) is insoluble and has only been isolated as individual molecules on a surface. However, all aromatic ladder polymers similar to those shown above would be expected to have useful organic semiconductor properties if they could be isolated in pure form.

The simplest example of an armchair GNR is the polynaphthalene 300 (FIG. 3).

An alternative approach to breaking down graphite for producing graphene nanoribbons or nanoplatelets is to build up the graphene structures from simpler organic compounds using synthetic organic chemistry techniques. This approach can be used to solve the problem of variation in the size and structure of the graphene fragments produced from processing graphite but does not solve the solubility problem of all but the simplest/smallest graphene structures. This approach is used to produce randomly oriented layers of graphene nanostructures on substrate surfaces through vacuum deposition and to produce solvent suspensions of these nanostructures. This organic synthetic approach is reviewed in Z. Chen, et al., Adv. Matl. 2020, 32, 2001893. A particular example produced on a gold substrate is portrayed in FIG. 4. This example stems from the synthesis of triphenylene from o-terphenylene (Bull. Chem. Soc. Japan 40 8, 1994-95 (2006).

There is a need for materials containing graphene nanoribbons and nanoplatelets that optimally apply the superior mechanical, electronic and other properties of these forms of graphene to practical applications.

An approach to materials that might incorporate graphene nanoribbons or nanoplatelets would be to incorporate the graphene into gels or aerogels. Liquid crystalline gels were initially investigated by Hikmet (Hikmet, R. A. M.; Anisotropic gels and plasticized networks formed by liquid crystal molecules; Liquid Crystals 9 (3); pp. 405-416 (1991)). The Kelly and O′Neill group at the University of Hull built on the work of Hikmet and others to develop a method whereby distributed heterojunction photovoltaic devices might be fabricated utilizing liquid crystalline gels (Carrasco-Orozco, et al., New Photovoltaic Concept: Liquid-Crystal Solar Cells Using a Nematic Gel Template; Advanced Materials 18 (13); pp. 1754-1758 (2006) and U.S. Pat. No. 7,820,907).

The Hull group's method of fabricating distributed heterojunction photovoltaic device active layers consists of the following steps:
1. A mixture containing 20 to 40 percent of a photocrosslinkable, nematic liquid crystalline, electron donating material (an electron donating reactive mesogen) and a non-crosslinkable nematic liquid crystal is prepared. This mixture is dissolved at a one percent concentration in a spin coating solvent. In the example given the reactive mesogen has the following formula:

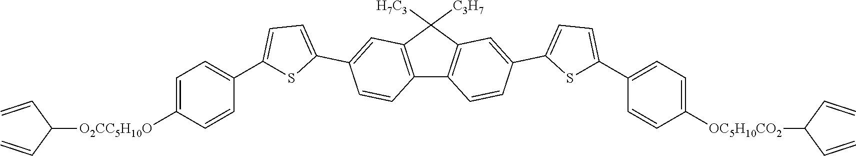

The non-crosslinkable nematic liquid crystal a racemic mixture of isomers having the formula:

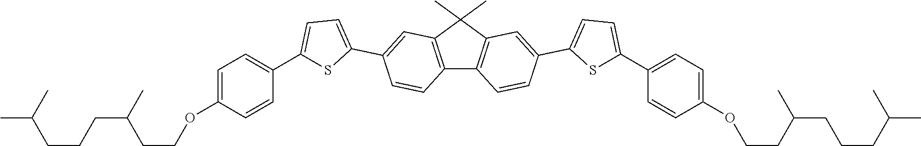 [SMILES: CC(C)CCCC(C)CCOc1ccc(-c2ccc(-c3ccc4c(c3)C(C)(C)c3cc(-c5ccc(-c6ccc(OCCC(C)CCCC(C)C)cc6)s5)ccc3-4)s2)cc1]

and the spin coating solvent is chloroform. No photoinitiator was used in the spin coating solution because it was found that 1,4-pentadien-3-yl crosslinking groups located at the opposite ends of the reactive mesogens molecules would crosslink without photoinitiator.
2. A substrate coated with indium-tin oxide and then PEDOT/PSS conductive polymer was spin coated with the liquid crystal solution and then exposed to 325 nm UV radiation from a HeCd laser forming a nematic gel.
3. The non-crosslinkable nematic liquid crystal was washed out of the nematic gel using additional chloroform. This step resulted in the formation of an aerogel film that maintained liquid crystalline order.
4. The electron accepting material, tris(8-hydroxyquinolinato)aluminium, was thermally deposited penetrating the voids in the aerogel and creating a distributed heterojunction layer that was shown to support a photovoltaic effect.

In other experiments it was shown that when a solution of an electron accepting material was spun onto nematic liquid crystalline aerogels similar to that prepared as described, bulk photovoltaic capable films were also formed.

US Patent Application 2003/0309328 improved upon the Hull group approach by utilizing chiral nematic liquid crystalline material as the non-crosslinkable liquid crystalline solvent into which the reactive mesogens was dissolved.

### BRIEF DESCRIPTION OF THE DRAWINGS

FIG. 1a. Illustrates the structure of graphene.

FIG. 1b. Illustrates the structure of a graphene nanoribbon with zig-zag edges.

FIG. 1c. Illustrates the structure of a graphene nanoribbon with armchair edges.

FIG. 2. Illustrates the structure of polyacene.

FIG. 3. Illustrates the structure of a a polynaphthalene.

FIG. 4. Illustrates a synthesis of a graphene nanoribbon on a surface.

FIG. 5a. Illustrates the structure of a polybenzothiophene.

FIG. 5b. Illustrates the structure of a polybenzofuran.

FIG. 5c. Illustrates the structure of a polyindole.

FIG. 6. Illustrates the generic structure of a type of heterographene nanoribbon.

FIG. 7. Illustrates the first step in the synthesis of a first type of heterographene nanoribbon.

FIG. 8. Illustrates an end group in the synthesis of a first type of heterographene nanoribbon.

FIG. 9. Illustrates the structure of an intermediate in the synthesis of a first type of heterographene nanoribbon.

FIG. 10. Illustrates two steps in the synthesis of a first type of heterographene nanoribbon.

FIG. 11. Illustrates the structure of a photoinitiator.

FIG. 12. Illustrates the structures of nematic liquid crystalline solvents used in fabricating nanoribbon aerogels.

FIG. 13. Illustrates the penultimate step in the synthesis of a first type of heterographene nanoribbon.

FIG. 14. Illustrates the final step in the synthesis of a first type of heterographene nanoribbon.

FIG. 15. Illustrates the structures of two photopolymerizable, nematic liquid crystalline electron accepting materials.

FIG. 16. Illustrates the structure of a chiral nematic liquid crystalline dopant.

FIG. 17. Illustrates the structure of a photopolymerizable chiral nematic liquid crystalline material.

FIG. 18. Illustrates the first step in the synthesis of a second type of heterographene nanoribbon.

FIG. 19. Illustrates the two steps in the synthesis of a second type of heterographene nanoribbon.

FIG. 20. Illustrates the structure of an intermediate in the synthesis of a second type of heterographene nanoribbon.

FIG. 21. Illustrates two steps in the synthesis of a second type of heterographene nanoribbon.

FIG. 22. Illustrates the final step in the synthesis of a third type of heterographene nanoribbon.

FIG. 23. Illustrates the final step in the synthesis of a fourth type of heterographene nanoribbon.

FIG. 24. Illustrates the first steps in the synthesis of a first type of graphene nanoribbon.

FIG. 25. Illustrates the penultimate step in the synthesis of a first type of graphene nanoribbon.

FIG. 26. Illustrates the final step in the synthesis of a first type of graphene nanoribbon.

FIG. 27. Illustrates the first step in the synthesis of a fifth type of heterographene nanoribbon.

FIG. 28. Illustrates an intermediate step in the synthesis of a fifth type of heterographene nanoribbon.

FIG. 29. Illustrates the penultimate step in the synthesis of a fifth type of heterographene nanoribbon.

FIG. 30. Illustrates the final step in the synthesis of a fifth type of heterographene nanoribbon.

FIG. 31. Illustrates the structure of a graphene nanoribbon structure in a second type of nematic liquid crystalline gel composite.

FIG. 32. Illustrates the first two steps in the production of a graphene nanoribbon structure in a second type of nematic liquid crystalline gel composite.

FIG. 33. Illustrates the third step in the production of a graphene nanoribbon structure in a second type of nematic liquid crystalline gel composite.

FIG. 34. Illustrates the fourth step in the production of a graphene nanoribbon structure in a second type of nematic liquid crystalline gel composite.

FIG. 35. Illustrates the penultimate step in the production of a graphene nanoribbon structure in a second type of nematic liquid crystalline gel composite.

FIG. 36. Illustrates the final step in the production of a graphene nanoribbon structure in a second type of nematic liquid crystalline gel composite.

FIG. 37. Illustrates the structure of a reactant in the synthesis of graphene nanofibers.

FIG. 38. Illustrates the final step in the production of a graphene nanoribbon structure in a third type of nematic liquid crystalline gel composite.

FIG. 39. Illustrates the first step in the synthesis of a sixth type of heterographene nanoribbon.

FIG. 40. Illustrates the second step in the synthesis of a sixth type of heterographene nanoribbon.

FIG. 41. Illustrates the third step in the synthesis of a sixth type of heterographene nanoribbon.

FIG. 42. Illustrates the fourth step in the synthesis of a sixth type of heterographene nanoribbon.

FIG. 43. Illustrates the fifth step in the synthesis of a sixth type of heterographene nanoribbon.

FIG. 44. Illustrates the sixth step in the synthesis of a sixth type of heterographene nanoribbon.

FIG. 45. Illustrates the final step in the synthesis of a sixth type of heterographene nanoribbon.

FIG. 46. Illustrates the structure of a family of photopolymerizable, liquid crystalline, electron accepting materials.

FIG. 47. Illustrates the final step in producing a graphene nanoplatelet structure in a nematic discotic liquid crystalline gel composite.

FIG. 48. Illustrates a nematic liquid crystalline solvent for gel spinning graphene nanoribbon fibers.

FIG. 49. Illustrates the structure of a monomer precursor for gel spinning heterographene nanoribbon fibers.

FIG. 50a. Illustrates the structure of a repeat unit in the molecular core of monomer precursors for gel spinning heterographene nanoribbon fibers.

FIG. 50b. Illustrates the structure of a second repeat unit in the molecular core of monomer precursors for gel spinning heterographene nanoribbon fibers.

FIG. 51. Illustrates the structure of a second repeat unit derivatized with a crosslinking group in the molecular core of monomer precursors for gel spinning heterographene nanoribbon fibers.

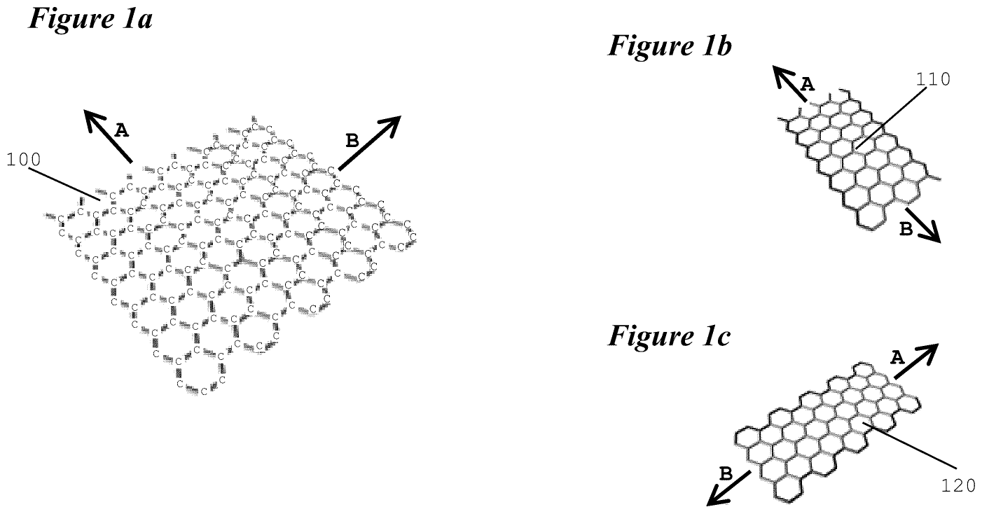

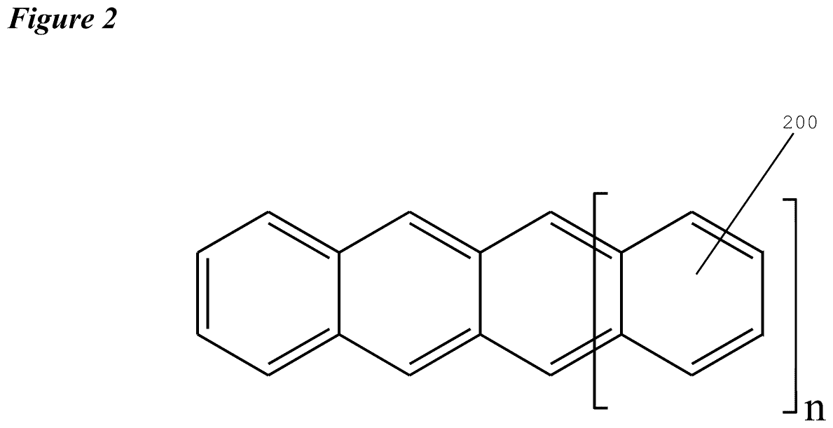

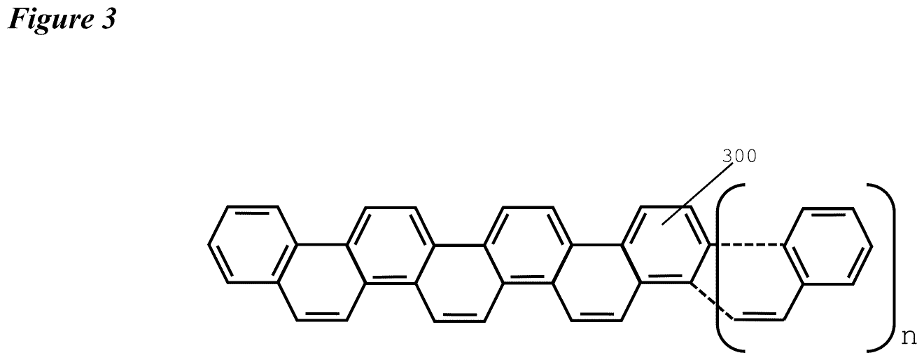

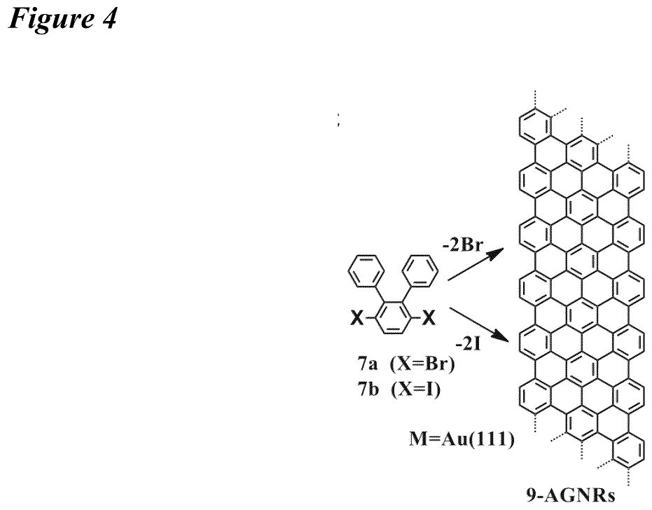

### DETAILED DESCRIPTION OF THE INVENTION

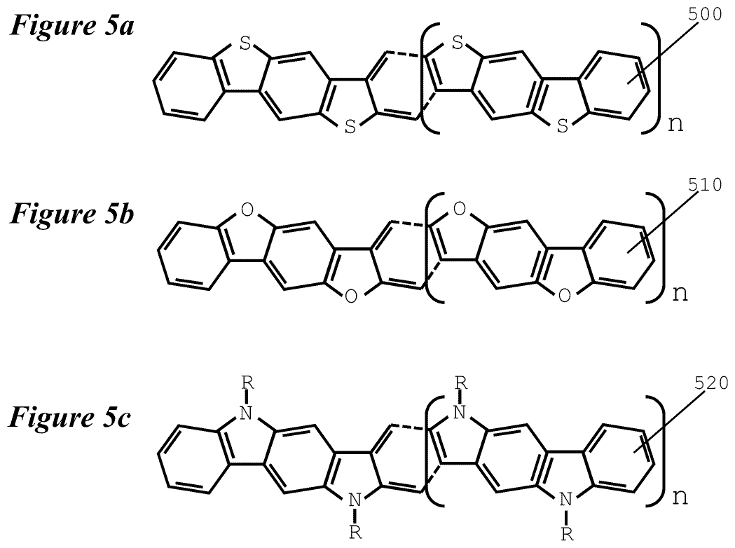

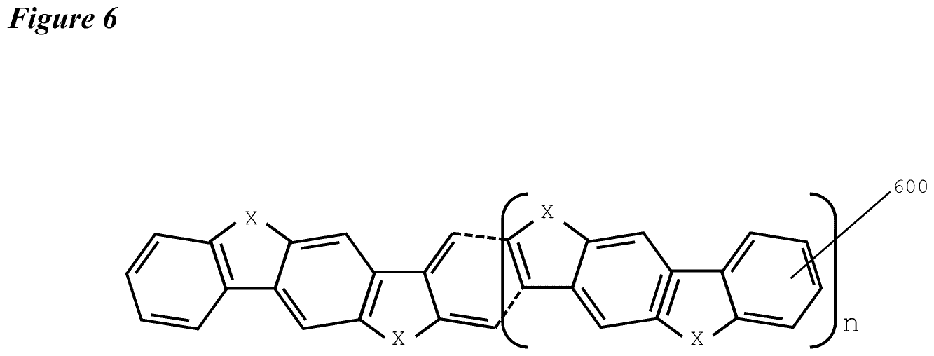

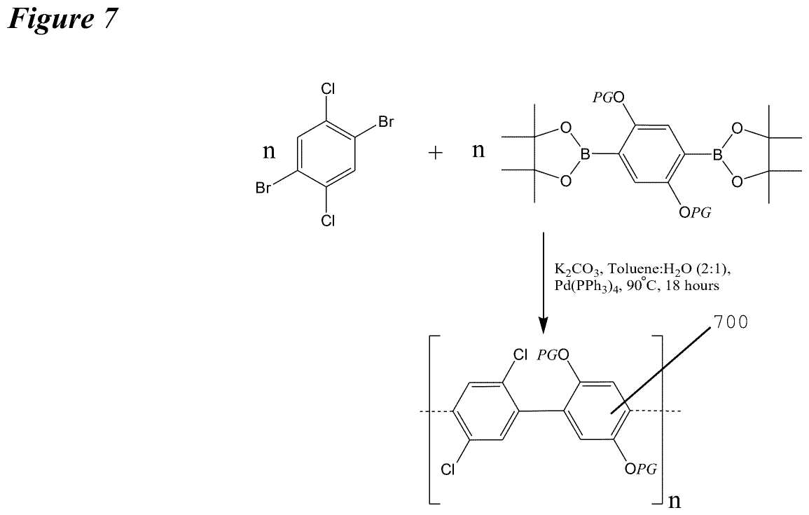

Particularly interesting applications of nanoribbon materials are electronic devices that comprise heterojunctions, e.g. diodes and transistors. Examples are diodes, light emitting diodes, transistors and light emitting transistors. In the case of commonly encountered inorganic electronics the materials used in heterojunction devices are basic semiconductor materials like silicon doped with positive or negative dopants like boron, gallium, phosphorus and arsenic. The contact between the positive p-doped and negative n-doped materials constitutes the heterojunction. Similarly, graphene nanoribbons may have heteroatoms added to their structure to produce electron donating nanoribbons (equivalent to p-doping) or electron accepting nanoribbons (equivalent to n-doping). Simple examples of p-doped nanoribbon materials analogous to polynaphthalene 300 material are polybenzothiophenes 500 (FIG. 5a), polybenzofurans 510 (FIG. 5b) and polyindoles 520 (FIG. 5c) where R=an alkyl group.
1. First embodiments of the invention are gel and aerogel materials that incorporate nanoribbon segments like 500, 510 and 520 having general formula 600 (FIG. 6) and methods for producing them. As an example, the first step in a fabrication method for gel materials incorporating structure 510 is the synthesis of oligomeric or polymeric compound 700 shown in FIG. 7. The two hydroxy groups on 2,5-bis(5,5-dimethyl-1,3,2-dioxaborinan-2-yl) hydroquinone are derivatized with protecting groups PG. PG may, for instance, be a tetrahydropyranyl group produced by reacting the substituted hydroquinone with 3,4-dihydropyran in dry diethyl ether in the presence of catalytic p-toluenesulfonic acid. The protected hydroquinone is then reacted with 1,4-dibromo-2,5-dichlorobenzene in a Suzuki arylation reaction. There are multiple reagent combinations that can be used to effect this reaction including the reagent combination shown in FIG. 7.

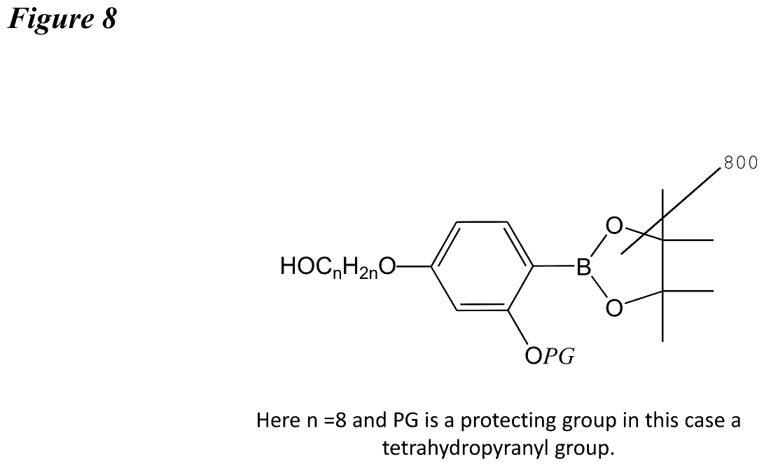

To produce oligomeric materials 4-(8-hydroxyoctyl-1-oxy)-2-(5,5-dimethyl-1,3,2-dioxaborinan-2-yl)phenol that has its phenolic hydroxy group protected with for instance a tetrahydropyranyl group 800 (FIG. 8) is added to the mixture as a terminating agent. The amount of terminating agent added will determine the average number of repeat units (n) in the polymer or oligomer molecules formed.

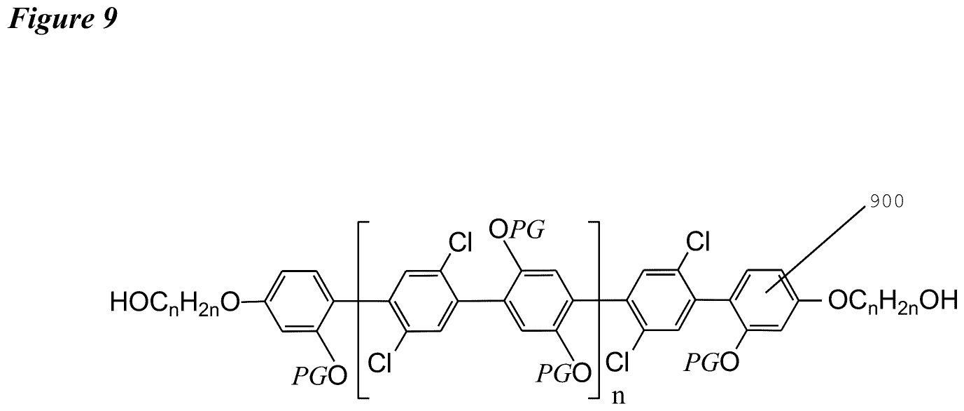

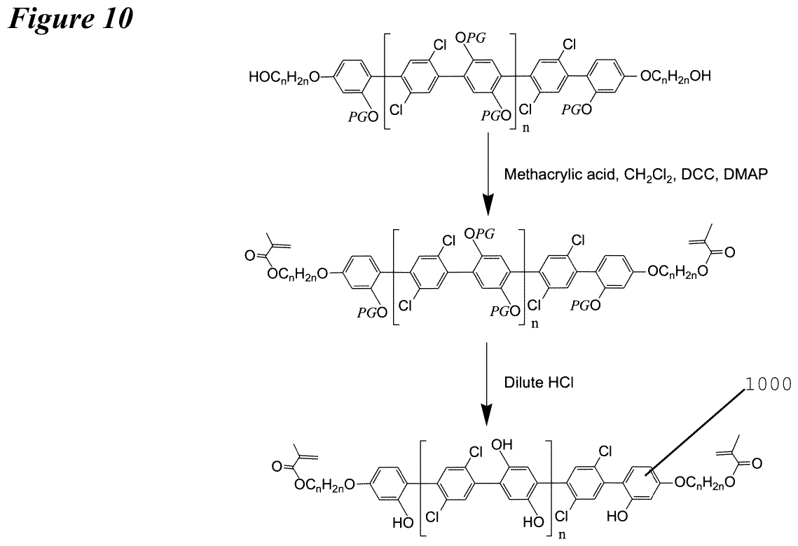

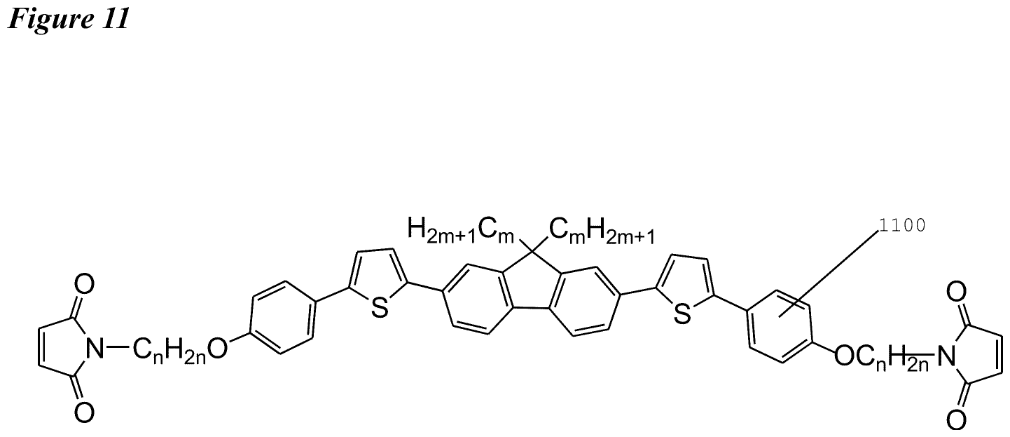

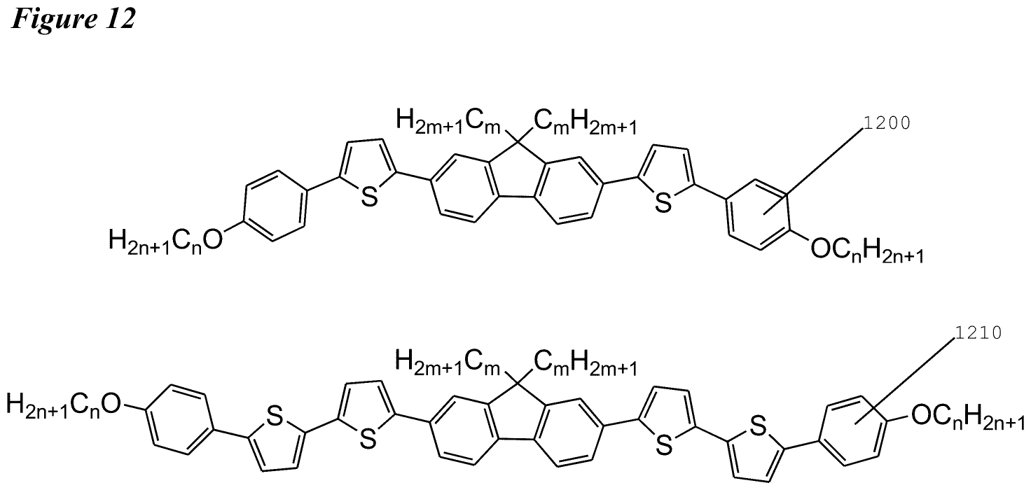

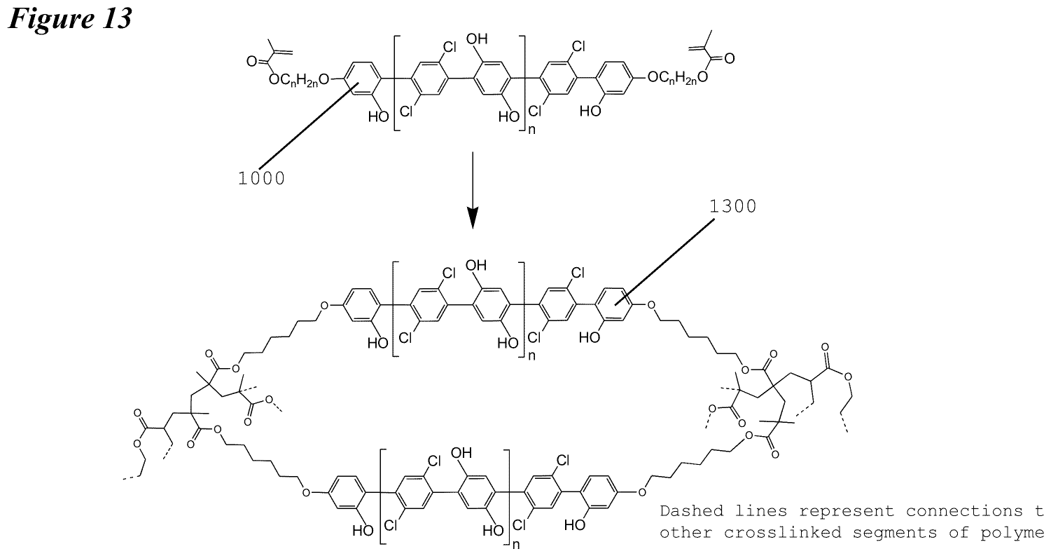

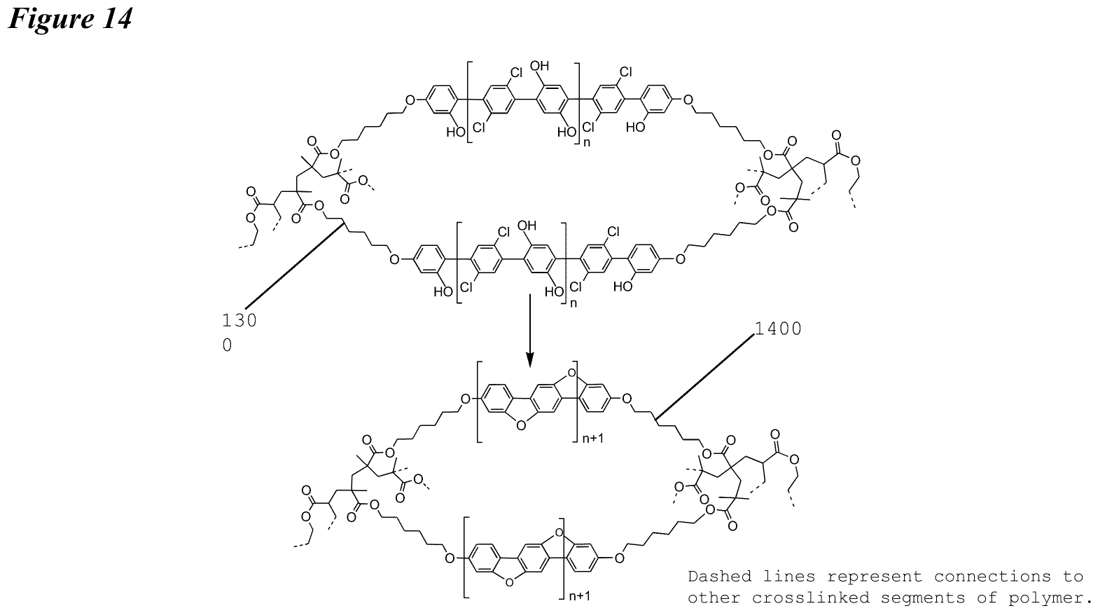

The resulting polymer can be symbolized by the formula 900 (FIG. 9).
2. The polymer is now derivatized with crosslinking groups, methacrylate groups in this example, and then the tetrahydropyranyl groups are removed yielding polymer 1000 (FIG. 10).
3. In one embodiment of the invention, the above product 1000 along with a photoinitiator material that may comprise molecules substituted with maleimide functional groups (for instance, one of materials 1100 (FIG. 11) where independently in each case n may have values from 5 to 12 and m may have values from 3 to 10) may be mixed with a non-crosslinkable nematic liquid crystalline solvent (for instance a mixture of materials 1200 and 1210 (FIG. 12) where independently in each case n may have values from 5 to 12 and m may have values from 3 to 10) to the extent of 20 to 30 weight percent concentration. This mixture of materials is then dissolved in a volatile solvent. The resulting solution is coated in a thin (e.g. 10 to 200 nm.) layer on a substrate and after the volatile solvent has evaporated off, the layer of material is crosslinked by exposure to UV radiation yielding a nematic liquid crystalline gel. The structure of the crosslinked polymer component 1300 (FIG. 13) of the nematic liquid crystalline gel along with the polymerization reaction is shown in FIG. 13. If the solution is coated onto a layer of liquid crystal alignment material such as rubbed PEDOT-PSS (poly(3,4-ethylenedioxythiophene) polystyrene sulfonate) a homogenously aligned layer of nematic liquid crystalline gel may be obtained.
4. The nematic liquid crystalline gel layer containing polymer 1300 is next washed with a solvent to removing the non-crosslinkable nematic liquid crystalline solvent yielding an aerogel. An important aspect of the invention is that while polymer or oligomer 1000 may not have nematic liquid crystalline order, dissolution of polymer or oligomer 1000 into the non-crosslinkable liquid crystalline host in the coated film induces nematic order in Polymer 1000 and once the photocrosslinking occurs producing Polymer 1300 that nematic order is locked in. That order may still be retained in the aerogel.
5. In the next step in producing this embodiment of the invention the reactants necessary for carrying out the ring closures to the aerogel material 1400 (FIG. 14) are intercalated into the aerogel. These could be the reactants necessary for the Buchwald-Hartwig or Ullman ether syntheses. For instance, a mixture of catalytic Pd(OAc)₂, catalytic tBuXPhos, potassium phosphate in toluene may be intercalated into the aerogel film to produce the Buchwald-Hartwig ring closure to an ether linkage between rings. A phase transfer catalyst such as tetrabutyl ammonium chloride may be required to insure the proximity of the potassium phosphate to the reaction site. Alternatively, an organic base such as DBU (1,8-diazabicyclo(5.4.0)undec-7-ene) may be used to replace the potassium phosphate. The aerogel film is then heated to promote the ring closure. The film is then rinsed with solvent and water to remove remaining reactants.

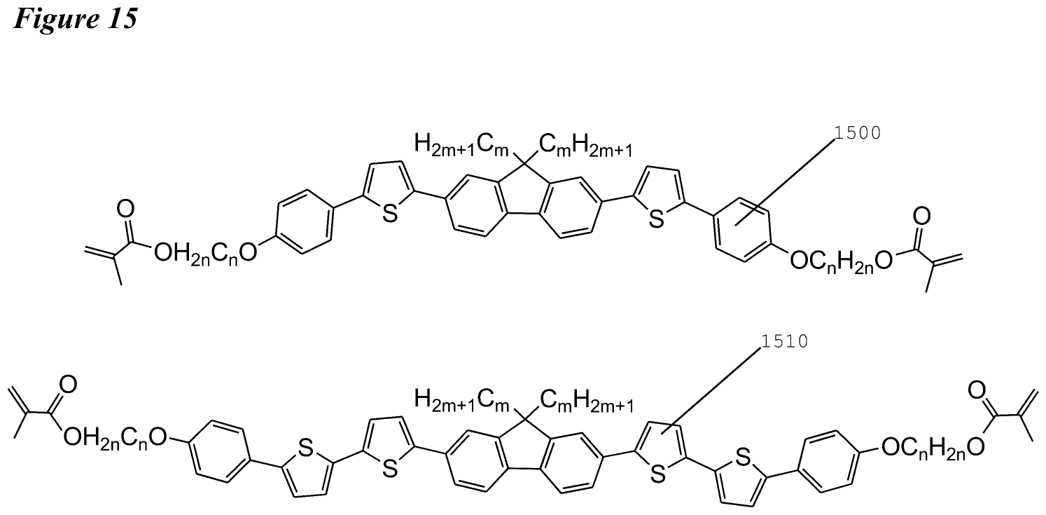

Other organic semiconductor materials may intercalated into the aerogel film to produce films useful in semiconductor devices such as organic photovoltaic devices, organic light emitting diodes (OLEDs) and organic transistors. The materials intercalated into the aerogel films may themselves be crosslinkable especially photocrosslinkable. An example of a photocrosslinkable material that may be intercalated into an aerogel film of polymer 1400 is a mixture of Materials 1500 and 1510 (FIG. 15) where independently in each case n may have values from 5 to 12 and m may have values from 3 to 10.

In step 2 of the above sequence of process steps outlined above, the protecting groups on the phenol functions are removed and then the dissolution of polymer 1000 in a non-crosslinkable liquid crystalline host and a coating solvent occurs. Depending on the polymer's molecular weight, there may be an issue with the solubility of polymer 1000 in the coating solution. In this case it may be advantageous to postpone the removal of the protecting groups until after the aerogel is formed in step 4. A somewhat bulky protecting group like the tetrahydropyranyl group or a trialkylsilyl group would enhance the polytmer's solubility. If the protecting group is, for instance, a tetrahydropyranyl group, it may be removed from the equivalent of polymer 1300 by treating the aerogel with dilute acid prior to step 5. The dilute acid solution and the remnants of the protecting groups may then be washed out of the aerogel before step 5.

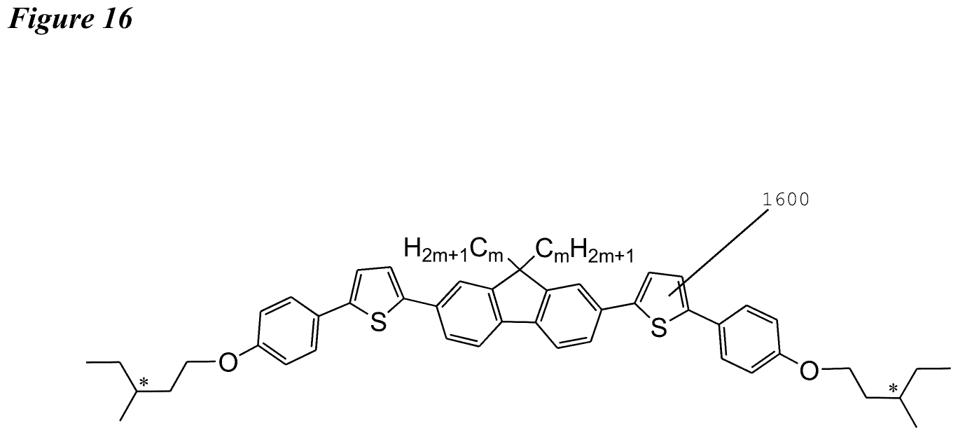

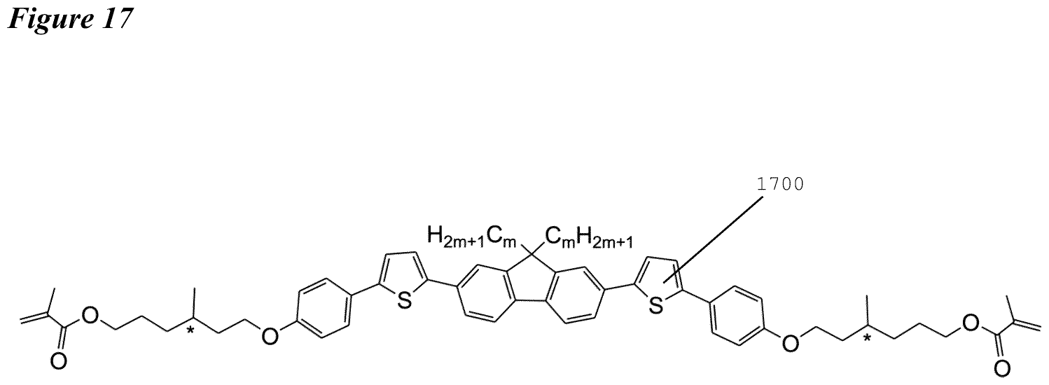

The non-crosslinkable nematic liquid crystalline solvent that, for instance, comprises materials 1200 and 1210 may be doped with a chiral material, for instance material 1600 (FIG. 16) where m may have values from 3 to 10 and an asterisk * denotes a chiral center. The liquid crystalline gel that results from the coating and polymerization mixtures of polymer 1000 in these chiral material containing solvents will have the helical structure associated with chiral nematic liquid crystals. The aerogel that contains ladder polymer produced from this chiral nematic liquid crystal gel may have electron donating or electron accepting liquid crystalline materials intercalated into its void spaces yielding an organic semiconductor composite that can be useful in C-OLEDs (U.S. Pat. No. 10,727,421) or organic photovoltaic devices (U.S. patent application Ser. No. 18/046,465). The intercalated materials may themselves be photocrosslinable and may be photocrosslinked after intercalation. Photocrosslinkable chiral liquid crystalline monomers such as Materials 1700 (FIG. 17) (where m may have values from 3 to 10 and an asterisk * denotes a chiral center) may be added to the intercalated material to assist in maintaining the desired helical structure.

A potential issue with the above method of producing organic semiconductor films containing nanoribbons is that the method relies on the aerogel films being mechanically stable enough to maintain void space in the films sufficient to accept intercalation of further reactants. It may be useful in this regard to mix photocrosslinkable oligomers having a similar molecular structure to compound 1000 with n equal to a smaller number (eg. between 1 and 10) into the mixture of photocrosslinkable materials that are mixed with the non-crosslinkable nematic liquid crystalline host in the solution to be coated on a substrate.

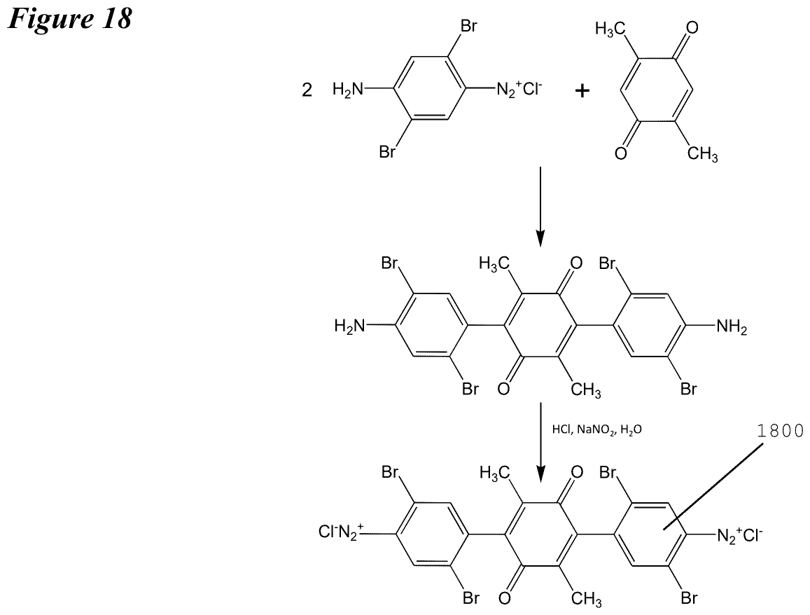

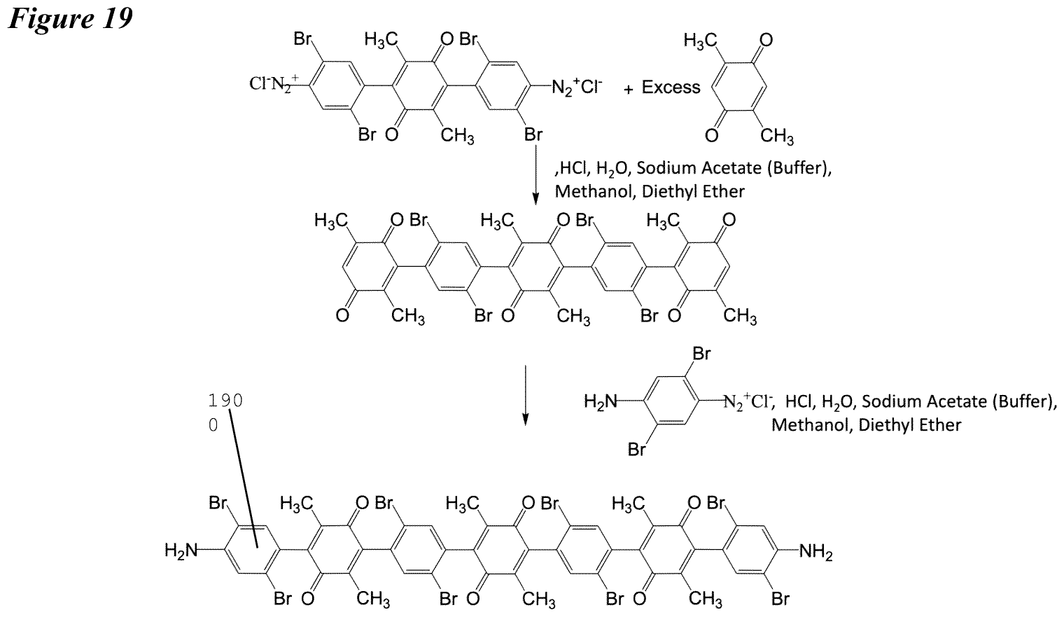

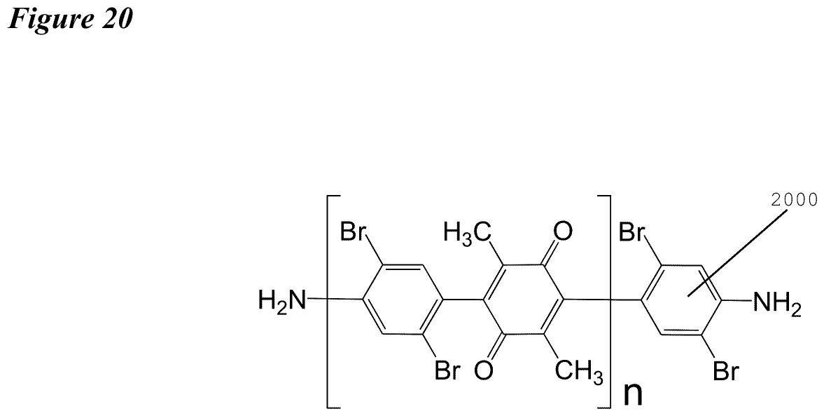

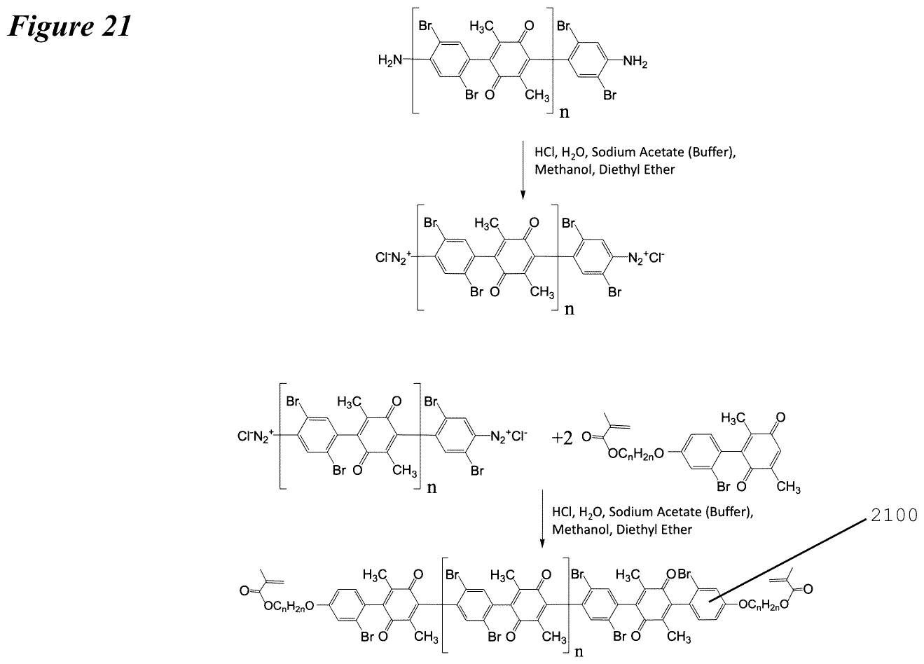

One synthesis of oligomers of this type (shown in FIGS. 18 through 21) utilizes the Meerwein arylation of quinones with diazonium salts. Tetraazo compound 1800 (FIG. 18) is prepared by diazotization of the p-phenylendiamine starting material followed by diarylation of the dimethylbenzoquinone starting material and then followed by tetrazotization of the resultant product to give 1800. Diamino oligomer 1900 (FIG. 19) is then produced by further arylations. Subsequent cycles of tetraazotization and arylation may be used to extend the length of the oligomer yielding members of the family of diamino oligomers having the general formula 2000 (FIG. 20). Tetraazotization of compounds 2000 and arylation with quinones substituted with (CH₂)ₙ spacers and crosslinking groups yields oligomeric monomer compounds 2100 (FIG. 21).

The quinone rings in compounds 2100 may then be reduced to hydroquinone rings under mild conditions, for instance, with sodium dithionite. The reduced versions of oligomer 2100 may then be mixed with polymer 1000 in the solution coated on a substrate. A mixture of reduced oligomers 2100 with varying values of n may be mixed with polymer 1000 in this way and also reduced oligomers 2100 may be used in the film formation procedure above without any polymer 1000 present. Once a film containing reduced oligomers 2100 structural units is produced by photopolymerization, the non-crosslinkable nematic host may be washed out of the film and then ring closure by means of the Buchwald-Hartman reaction may be carried out to produce a film containing nanoribbon oligomer structural units.

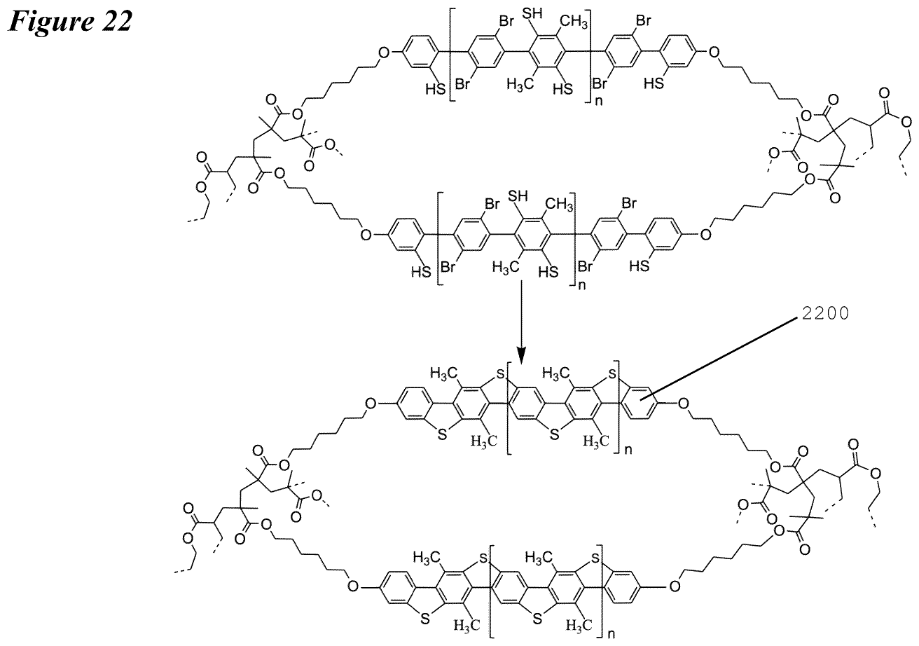

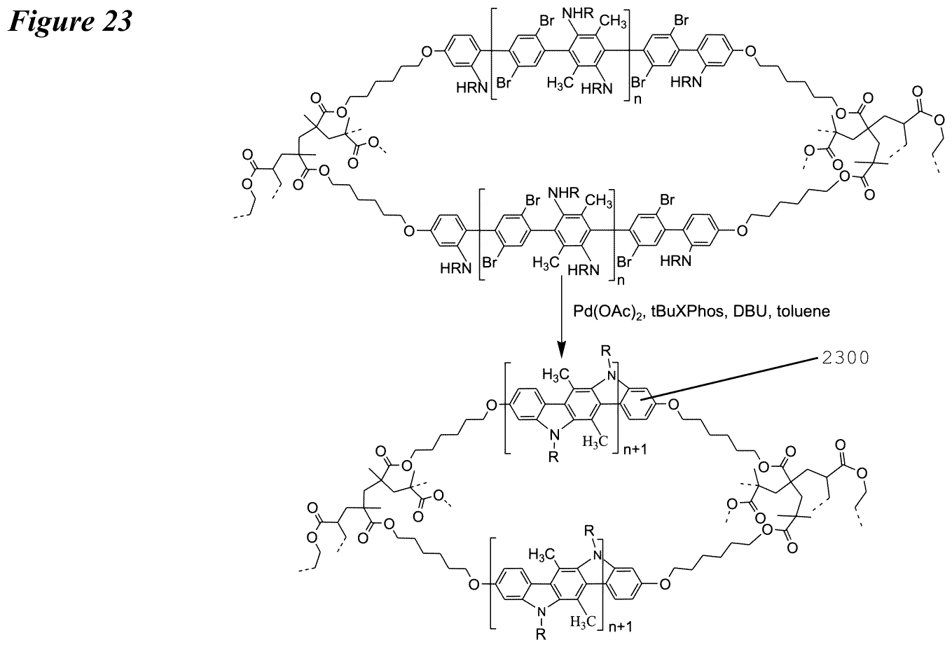

The Buchwald-Hartwig ring closure used to produce polymer 1400 above may also be used to produce nanoribbons that incorporate five membered rings containing sulfur and nitrogen atoms as well as oxygen atoms. An example of incorporating sulfur atoms is the synthesis of polymer 2200 (FIG. 22) and an example of incorporating nitrogen atoms is the synthesis of polymer 2300 (FIG. 23) below. In each case the precursor polymer was produced by steps analogous to those used in the formation of polymer 1300 above.

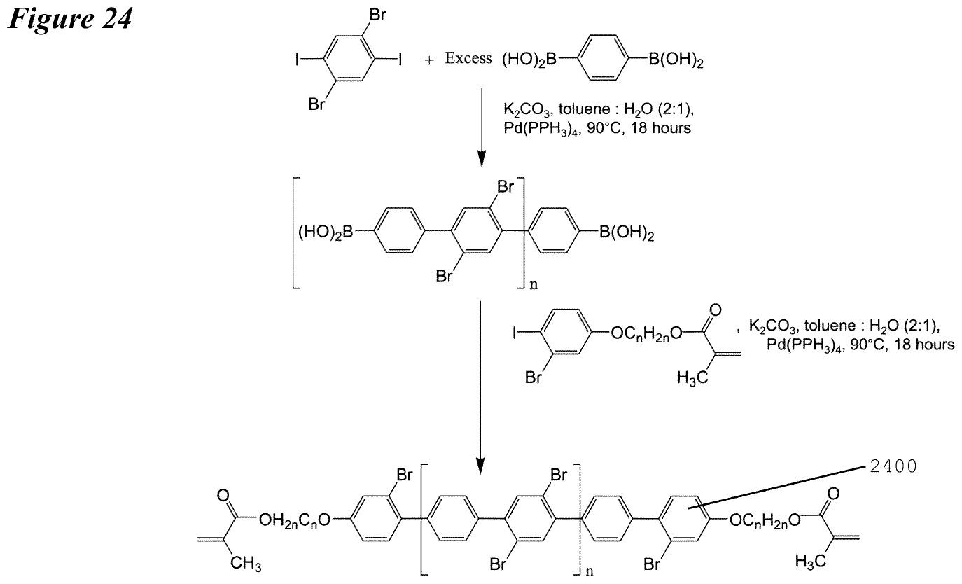

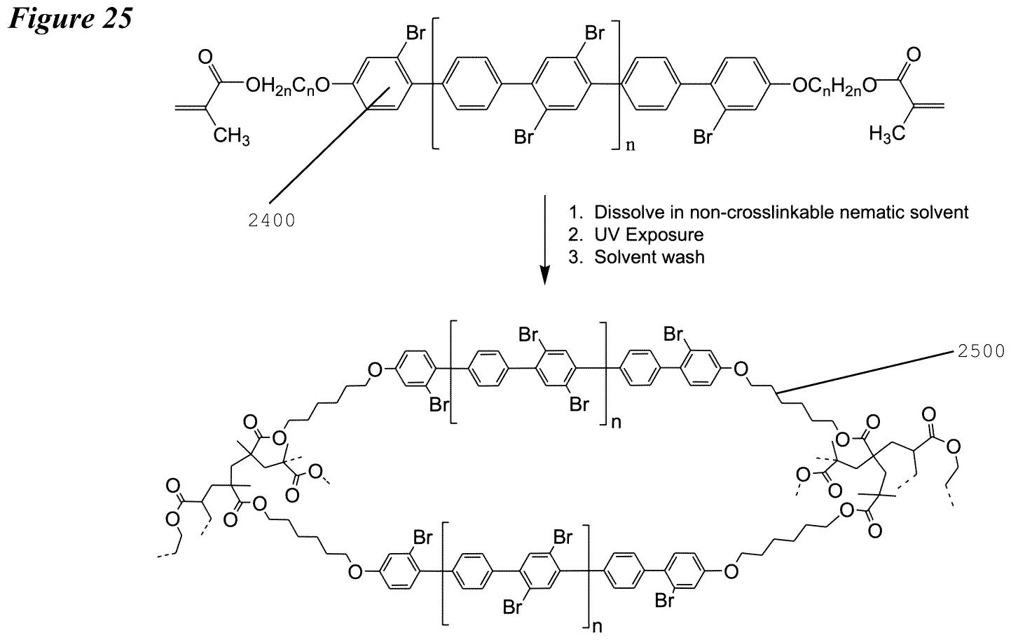

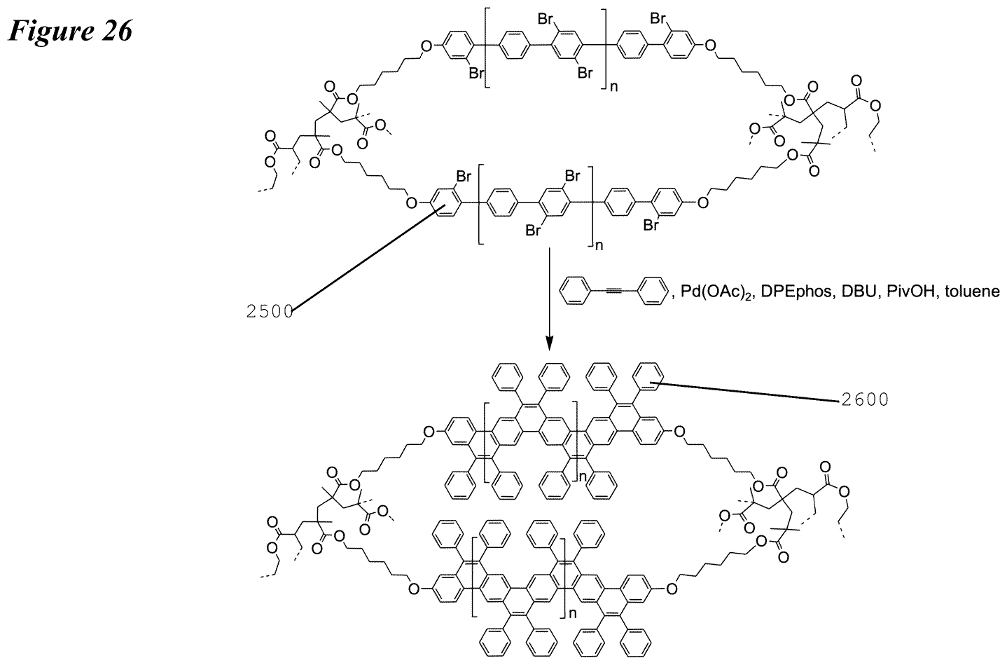

A procedure similar to that outlined in steps 1 through 5 used to produce polymer 1400 may be used to produce aerogels containing graphene nanoribbons that contain no hetero atoms and that are synthesized using the ring closure of six-membered fused rings. The synthetic steps of a procedure of this type are shown FIGS. 24 through 26. Monomer compounds 2400 (FIG. 24) are produced using a series of Suzuki arylations. These monomers 2400 are dissolved in a non-crosslinkable nematic solvent, coated onto a substrate and irradiated with ultraviolet light yielding a gel with nematic liquid crystalline order and with a polymer scaffolding 2500 (FIG. 25) containing nanoribbon precursor functional units. The gel containing polymer scaffolding 2500 is rinsed with solvent to yield an aerogel. The aerogel containing polymer 2500 is reacted with tolane (diphenylacetylene) in the presence of palladium acetate catalyst yielding the graphene nanoribbon aerogel 2600 having nematic liquid crystalline order.

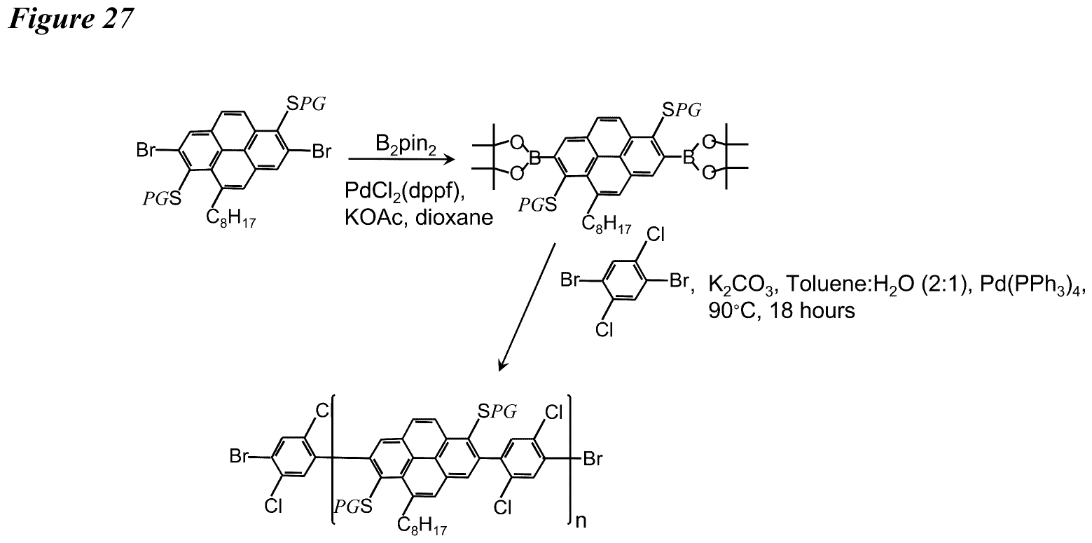

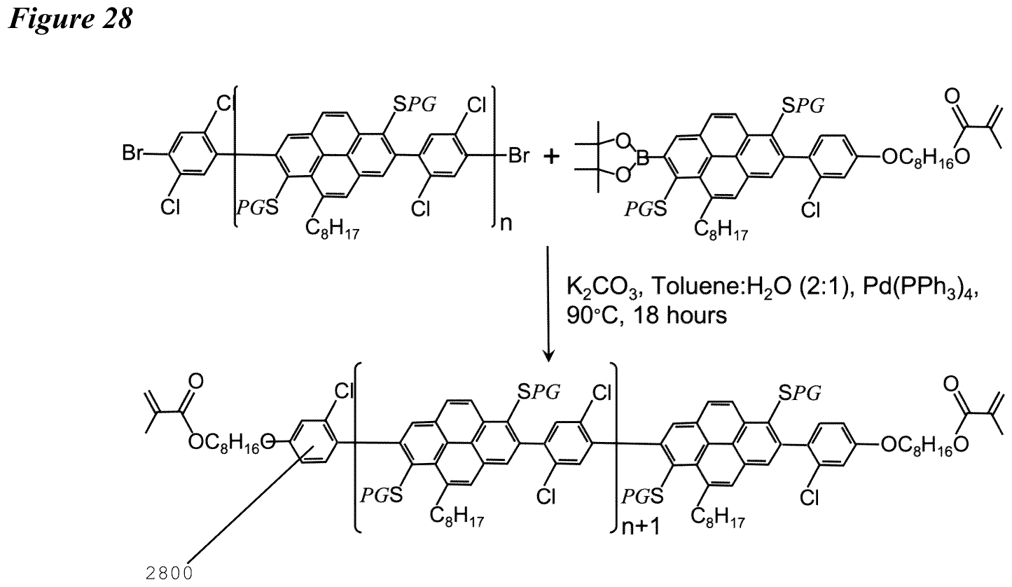

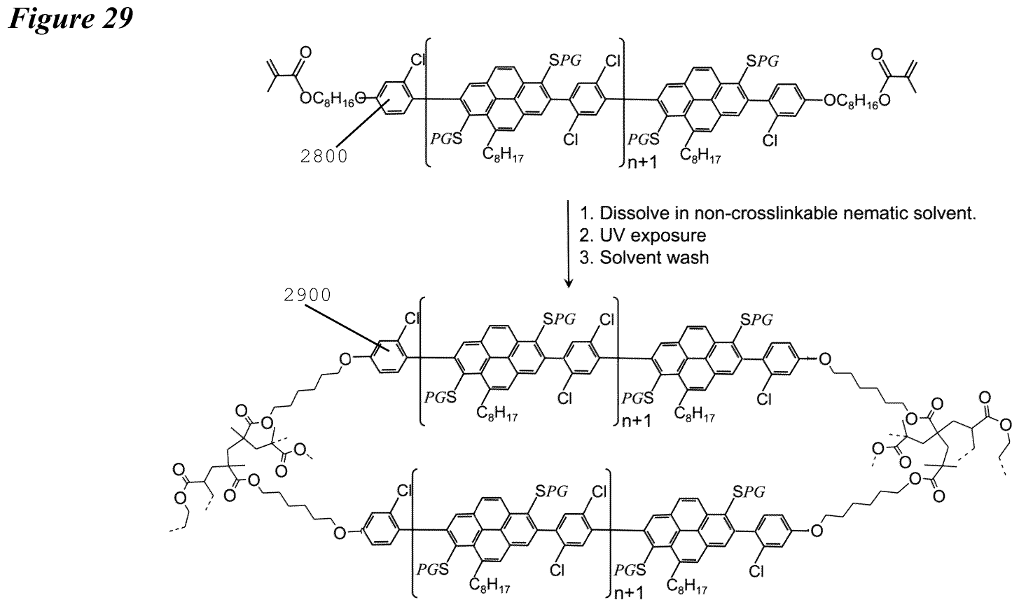

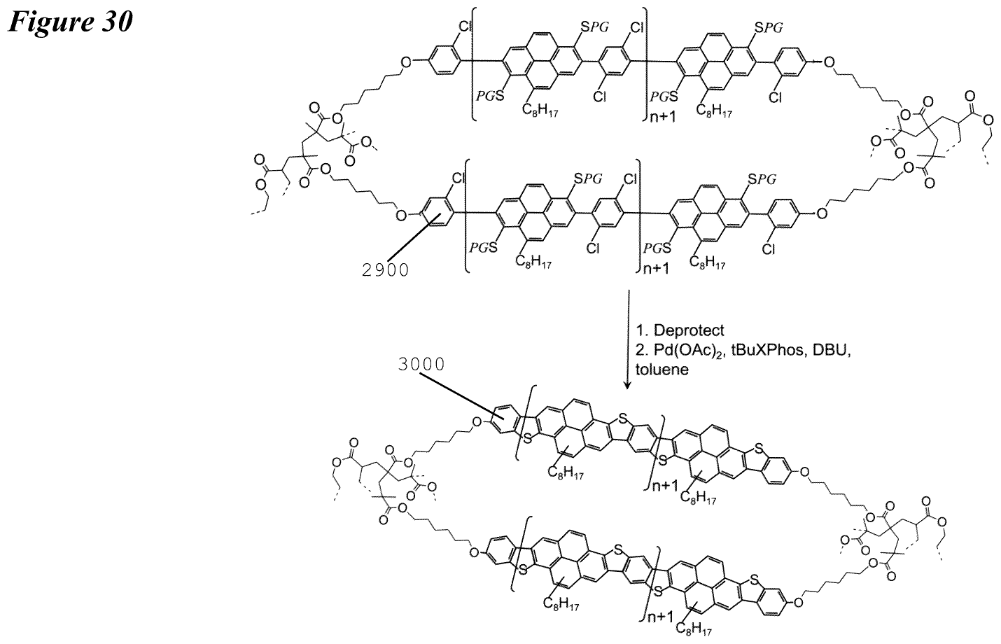

The aromatic ring systems that make up the resultant nanoribbon aerogels and composites need not be limited to those produced from starting materials containing single benzene rings. The starting materials may also comprise fused multi-ring aromatic compounds, heterocyclic aromatic compounds or fused multi-ring heterocyclic aromatic compounds. An example of such a synthesis is shown in FIGS. 27 through 30. The synthesis of monomeric oligomeric or polymeric monomers 2800 through a series of Suzuki arylations is detailed in FIGS. 27 and 28. These monomers 2800 are dissolved in a non-crosslinkable nematic solvent, coated onto a substrate and irradiated with ultraviolet light yielding a gel with nematic liquid crystalline order and with a polymer scaffolding 2900 (FIG. 29) containing nanoribbon precursor functional units. The nematic liquid crystalline solvent is now washed out of the gel with a solvent yielding an aerogel with scaffolding 2900. Next hydroxy groups in the nanoribbon precursor functional units are deprotected and the Buchwald-Hartwig etherization reaction is carried out yielding an aerogel 3000 having uniformly aligned nanoribbon functional units.

An issue with embodiments of the invention already described is that the chemically induced ring closures involve reactants that may be difficult to completely remove from the aerogel or gel product materials. Reactants such as palladium catalysts can adversely effect the performance of these materials especially when they are incorporated into electronic devices. Further embodiments of the invention avoid this problem by both forming the gel scaffolding through polymerization and ring closing the nanoribbon precursors through light exposure of different wavelengths. This sort of multiple exposure photochemical process is termed orthogonal photochemistry.

An embodiment of the invention involving orthogonal photochemistry is the following fabrication process.
1. Nanoribbon precursor material along with a long wave UV/visible light activated photoinitiator material are mixed with a non-crosslinkable nematic liquid crystalline solvent preferably with the material to nematic solvent concentration in the mixture being between 10% and 40%. This mixture is then dissolved in a coating solvent (e.g. dichloromethane) at a concentration usually between 0.5% and 2.0%. This mixture is coated or printed down onto a substrate surface and the coating solvent flashes off leaving a nematic liquid crystalline film.

The nanoribbon precursor material has a molecular structure that may be represented as B-S-A-S-B wherein A is a rod-like, roughly linear core of aromatic rings, heteroaromatic rings, aromatic ring systems or heteroaromatic ring systems concatenated together through single bonds. S are flexible spacers connected to opposite ends of the elongated molecular core. For instance, S may be a normal alkane functional unit connected at one end to the molecular core and at the other end to functional unit B. Spacers S may also be branched alkanes and one or more of the methylene groups that make up the alkanes may be substituted with heteroatoms such as oxygen or sulfur or the methylene groups may be substituted with functional groups such as carbonyl groups, ether groups, carbonato groups, sulfoxy groups or sulfonyl groups. The S spacer functional units at opposite ends of the molecule may be chosen independently. B are crosslinking groups such as methacrylate groups, maleimide groups, vinyl ether groups and 1,4-pentadiene-3-yl groups. Because the connections between aromatic groups making up the molecular core A are single bonds, these nanoribbon precursor molecules are considerably more solvent soluble than the product nanoribbon structures they will be converted into.
2. The nematic film is subjected to a patterned exposure with visible light (e.g. 405 nm wavelength) or long wave UV light (e.g. 395 nm wavelength). The irradiation with light crosslinks the B groups in the B-S-A-S-B molecules connecting the molecules together through the B groups. The result is a patterned nematic gel film that comprises, in exposed areas, a network or scaffolding of interconnected molecular cores. The molecular cores are connected to each other through the spacers S and the crosslinker material, e.g. polymethacrylate. The interstices between the scaffolding constituents are filled with uncrosslinked nematic LC. While the B-S-A-S-B material may not be liquid crystalline in nature itself, if its molecules have a sufficiently high length to width aspect ratio, its molecules will be constrained by the surrounding nematic material to adopt nematic ordering and this nematic order will be locked into place in the scaffolding by the crosslinking.
3. Optionally, the nematic gel film may now be irradiated shorter wave UV at a wavelength that photoinduces the ring closure reaction of precursors to nanoribbon structures. It may be important that the longer wave irradiation of step 2 does not induce ring closure or the structure of nematic composite gel may be affected.
4. The nematic liquid crystalline gel layer containing crosslinked molecular cores is next washed with a solvent to remove the non-crosslinkable nematic liquid crystalline solvent and any unexposed material yielding an aerogel. The crosslinking ensures that nematic order is still maintained in the scaffolding material.
5. If optional step 3 above was not carried out, the nematic aerogel film may now be irradiated wave shorter wave UV at a wavelength that photoinduces the ring closure reaction of precursors to nanoribbon structures.
6. Other organic semiconductor materials, either crosslinkable or non-crosslinkable, may now be intercalated into the aerogel. If the intercalated material is photocrosslinkable, the crosslinking may be carried out with UV exposure. Alternatively the aerogel film may be allowed to collapse down minimizing the interstitial volume and producing a film comprising nanoribbons and crosslinking material exclusively.

A second embodiment of the invention is a gel material comprising nanoribbon structures connected together into a molecular scaffolding by means of crosslinking material. (In this discussion nanoribbon means either graphene nanoribbons or graphene-like nanoribbon that contains heteroatoms and heteroatom containing ring of interconnected atoms with five, six, or some other number of atoms in the rings.) The gel material further comprises interstitial volumes distributed through the molecular scaffolding wherein the interstitial volumes are filled with either air or an amorphous, glassy, and/or polymeric material.

In another embodiment of the invention the nanoribbon structures in the molecular scaffolding are aligned with nematic LC order. The material in the interstitial volumes may also have nematic LC order and be aligned with its molecular backbones parallel to the alignment direction of the nanoribbon structures. The gel material may form a layer on a substrate.

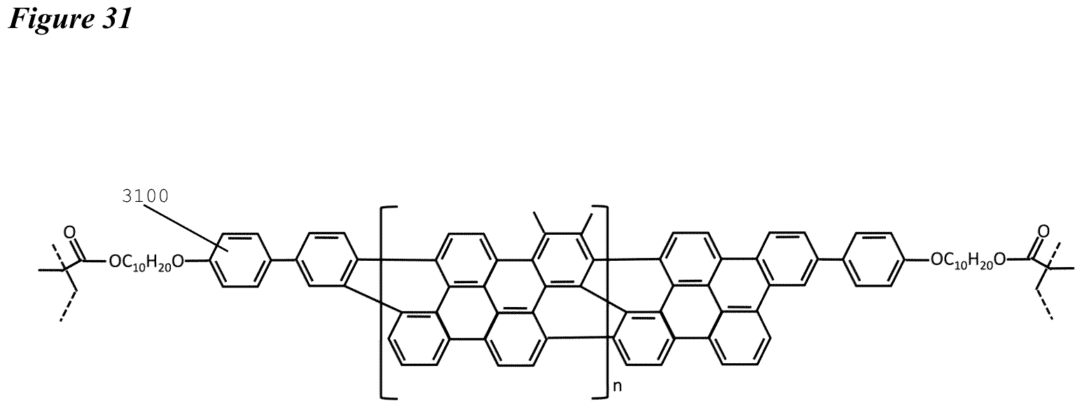

An example of the synthetic fabrication of the nematic LC/nanoribbon gel composite material of the invention is shown in FIG. 31. This is the synthesis of the graphene nanoribbon polymer gel compound 3100 (FIG. 31) where n=2. Dashed lines represent connections to other graphene structures through flexible spacers.

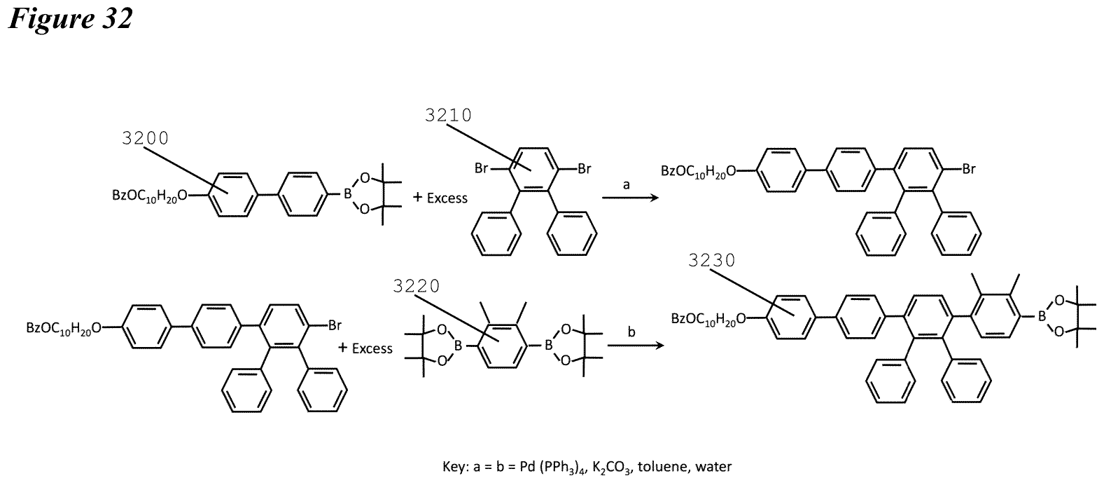

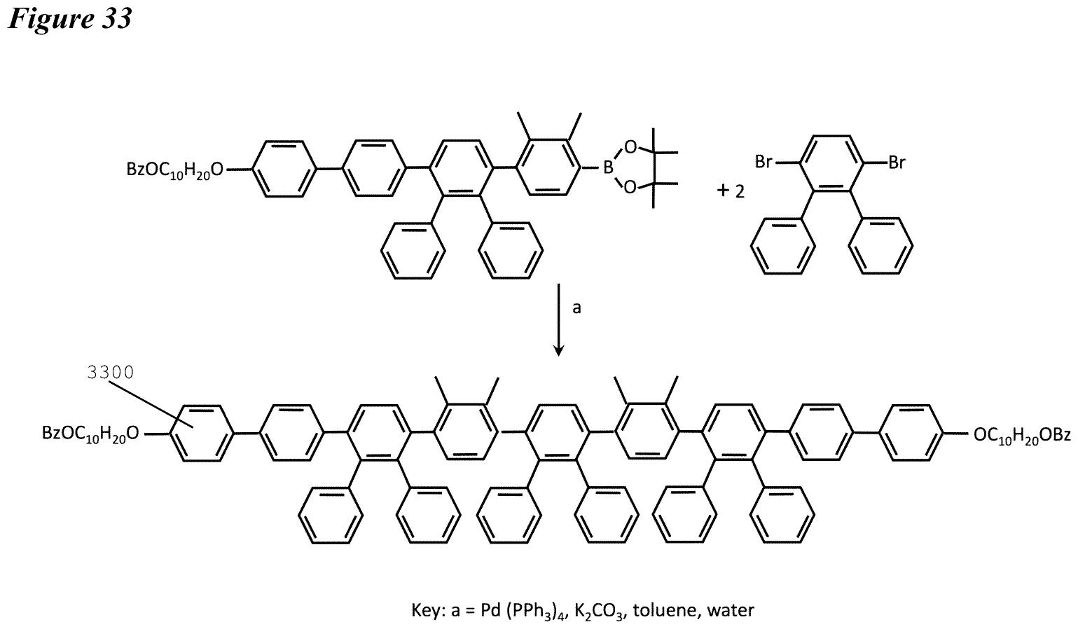

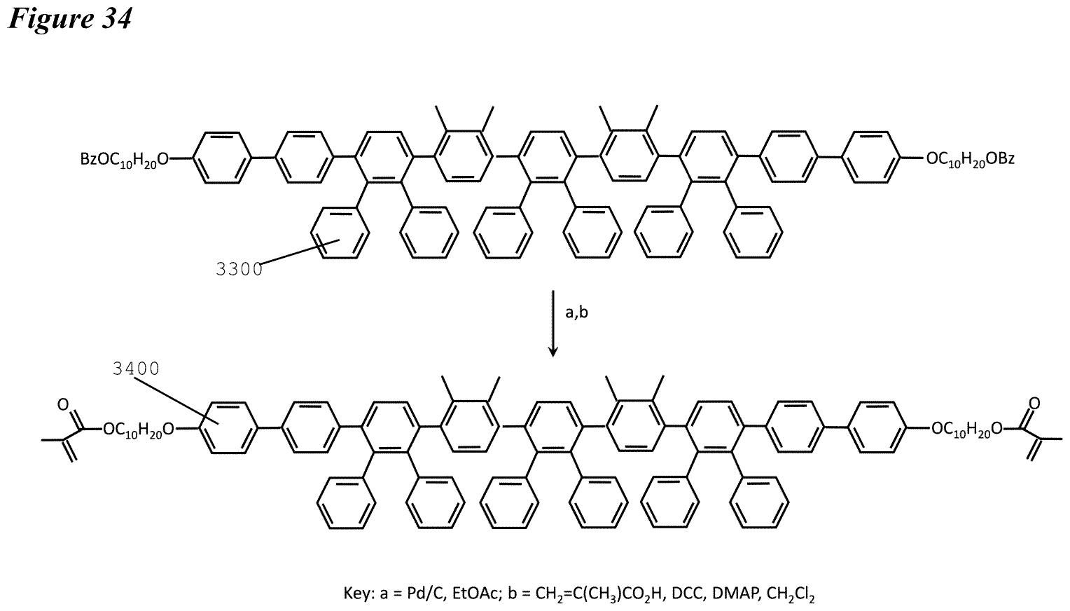

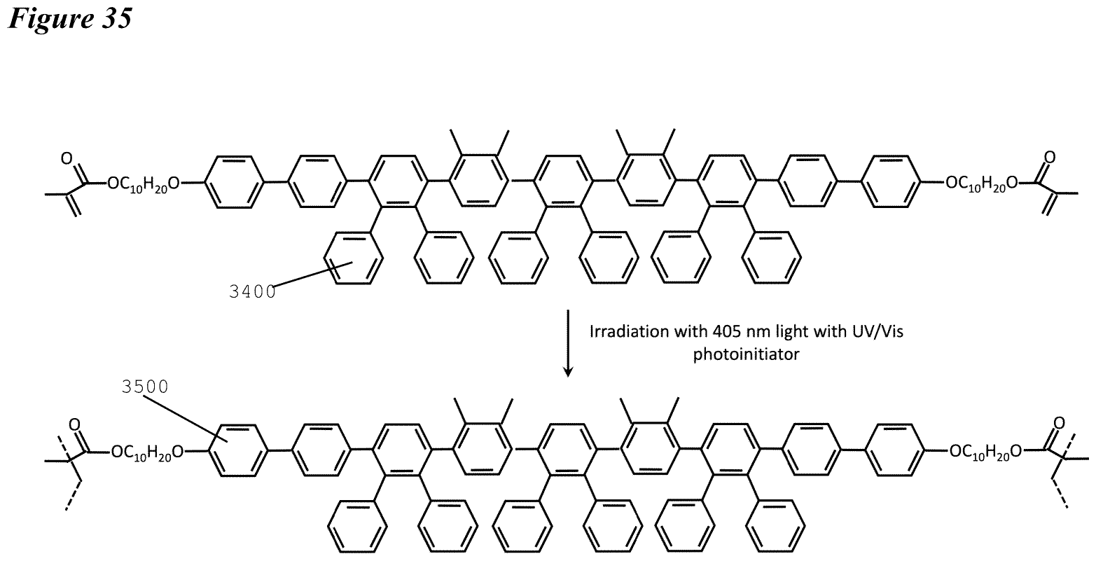

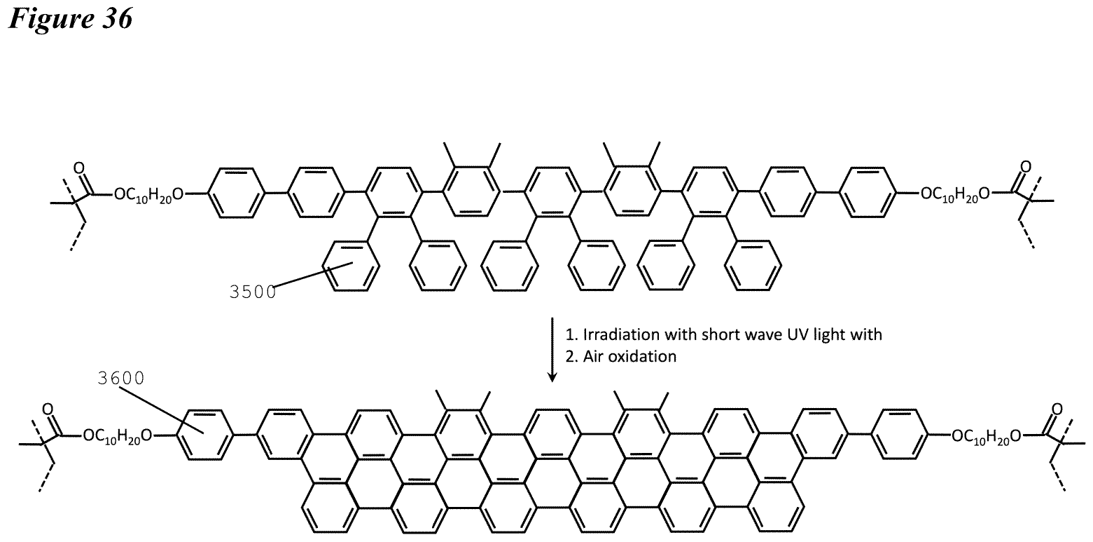

In FIG. 32 compound 3210 may be obtained from commercially available 3,6-o-phenylenediamine by tetraazotizing it and reacting the tetraazo salt with potassium iodide to yield 1,4-dibromo-2,3-diodobenzene. This compound can then undergo Suzuki coupling reactions with phenylboronic acid to yield compound 3210. Further Suzuki coupling reactions involving compounds 3210 and 3220 adding further repeat units to compound 3230 could be carried out leading to compounds having generic structure 3100 with n>2. Equal amounts of compounds 3210 and 3220 may undergo Suzuki coupling leading along with a small amount of compound 3200 leading to polymeric material having generic structure 3100 with n being a larger number. Further Suzuki coupling with 3210 leads to intermediate 3300 (FIG. 33). Deprotection and a Steglich esterification of compound 3300 yields monomer 3400 (FIG. 34). This monomer is mixed with a nematic liquid crystalline solvent and a long wave UV/visible photoinitiator and spin coated onto a substrate. Photocrosslinking of compound 3400 with visible light produces a nematic liquid crystalline gel with graphene nanoribbon precursor polymer scaffolding 3500 (FIG. 35). Dashed lines represent connections to other precursor molecular cores. The nematic solvent material may now be washed out of the precursor film yielding an aerogel. Irradiation of the precursor film with short wave UV light converts the precursor molecular cores in aerogel polymer scaffolding 3500 into graphene nanoribbon segments in aerogel polymer scaffolding 3600 (FIG. 36).

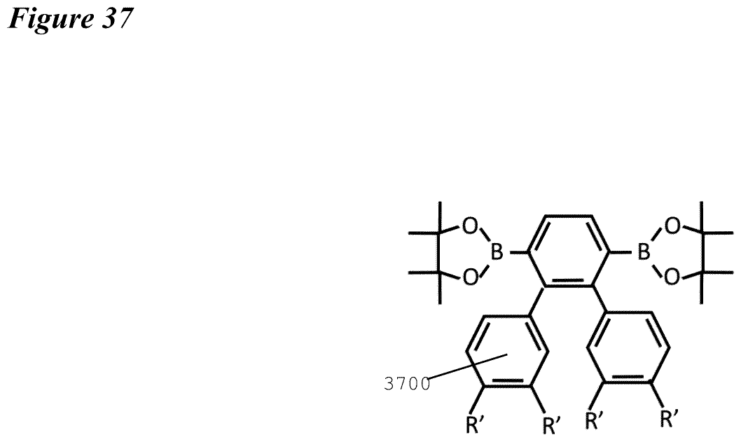

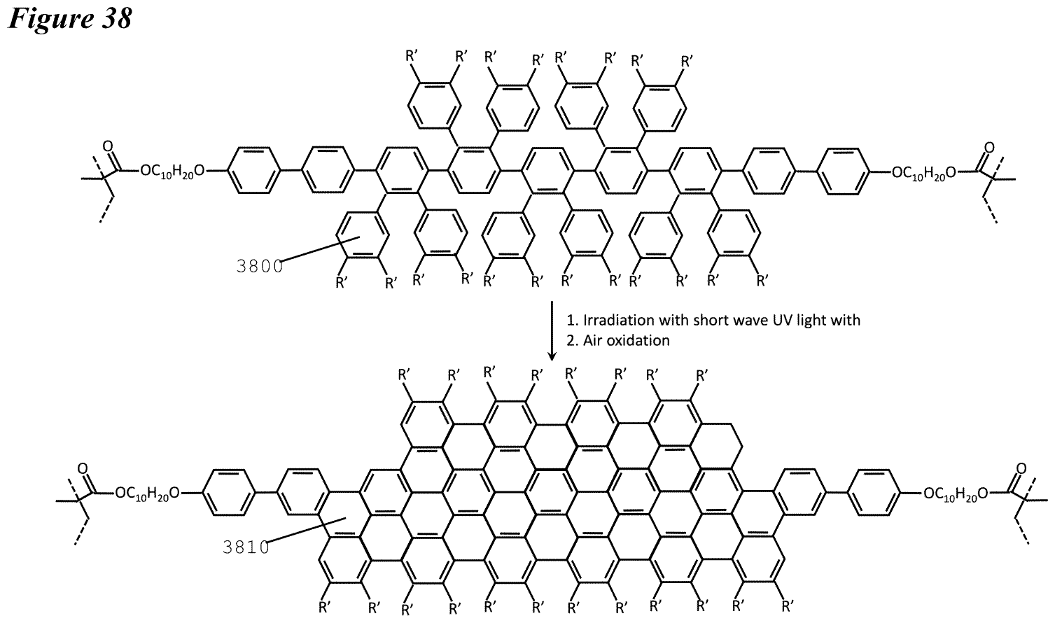

In another embodiment of the invention, the synthetic fabrication of another nematic LC/nanoribbon gel composite material, if Compound 3700 (FIG. 37) were substituted for compounds 3210 and 3220 in the synthetic scheme of FIGS. 32 through 37, the equivalent synthetic step to that in FIG. 36 would be the one shown in FIG. 38 that yields polymer compound 3810. Unfortunately, conversion to compound 3810 is not complete in this case. However, reaction of compound 3800 with a Lewis acid such as AlCl₃, FeCl₃ or BF₃ (the Scholl reaction) does yield complete conversion.

The purpose of the lateral R′ groups, for instance n-octyl groups, is to sufficiently solubilize Compound 3800 to allow a uniform nematic film to be produced. Compound 3800 may have to be extended one or two repeat units in length by means of additional Suzuki coupling reactions to yield a sufficiently high aspect ratio to allow good alignment by the nematic host during crosslinking.

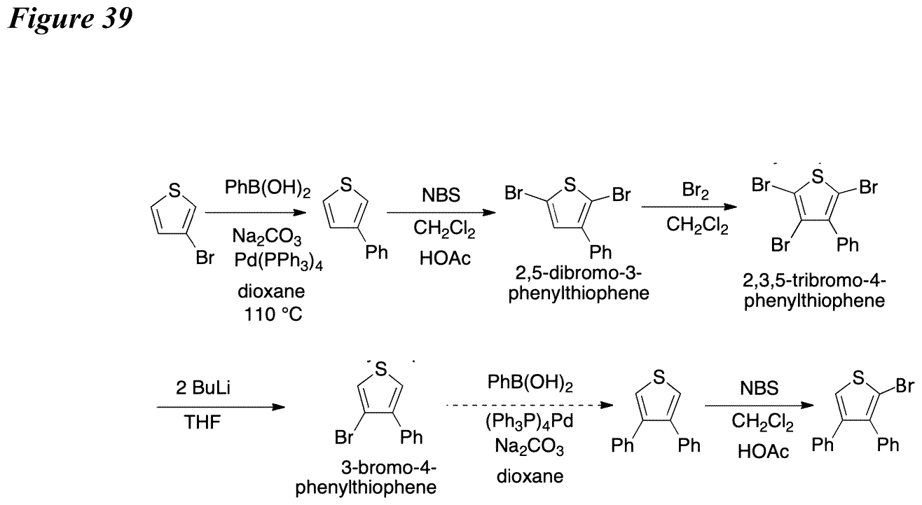

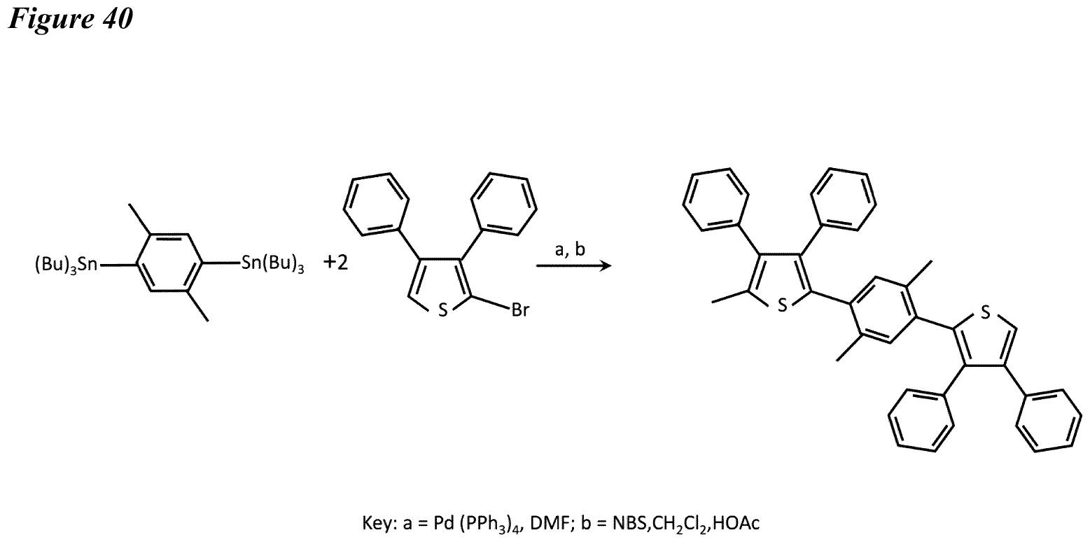

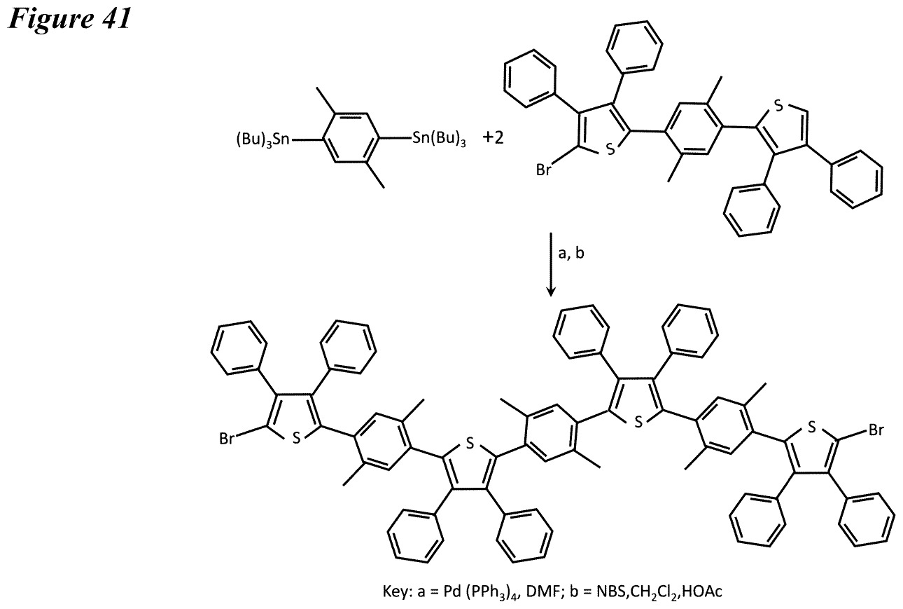

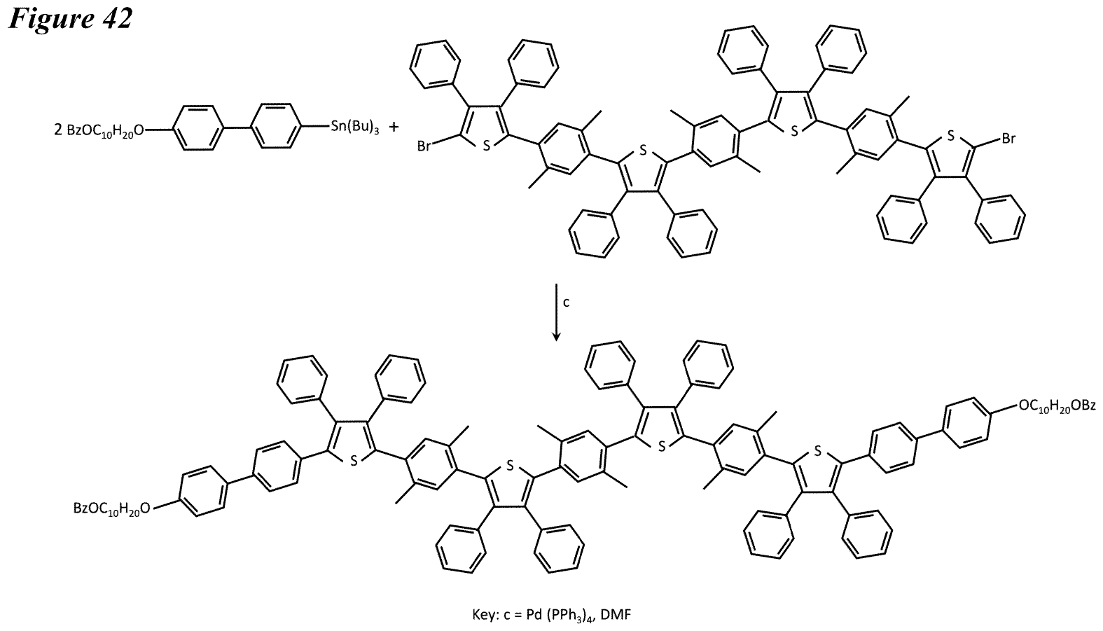

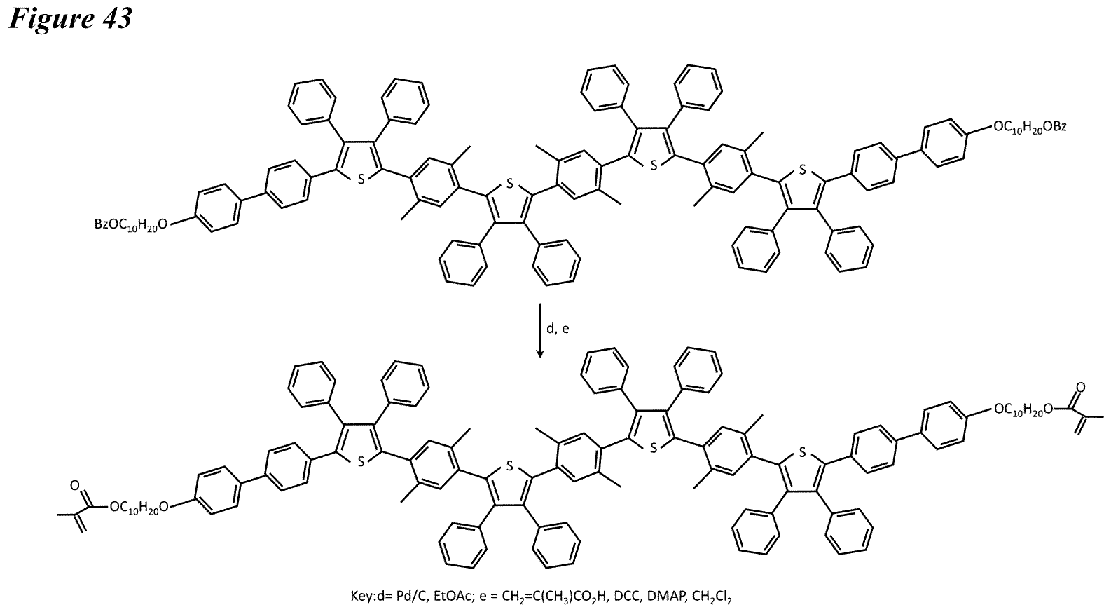

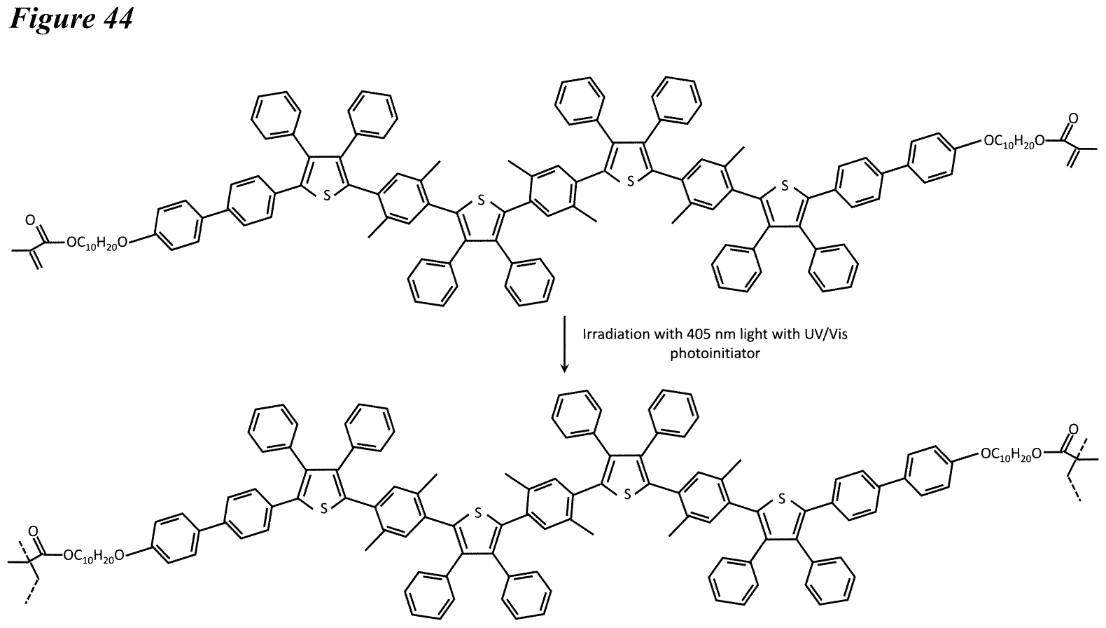

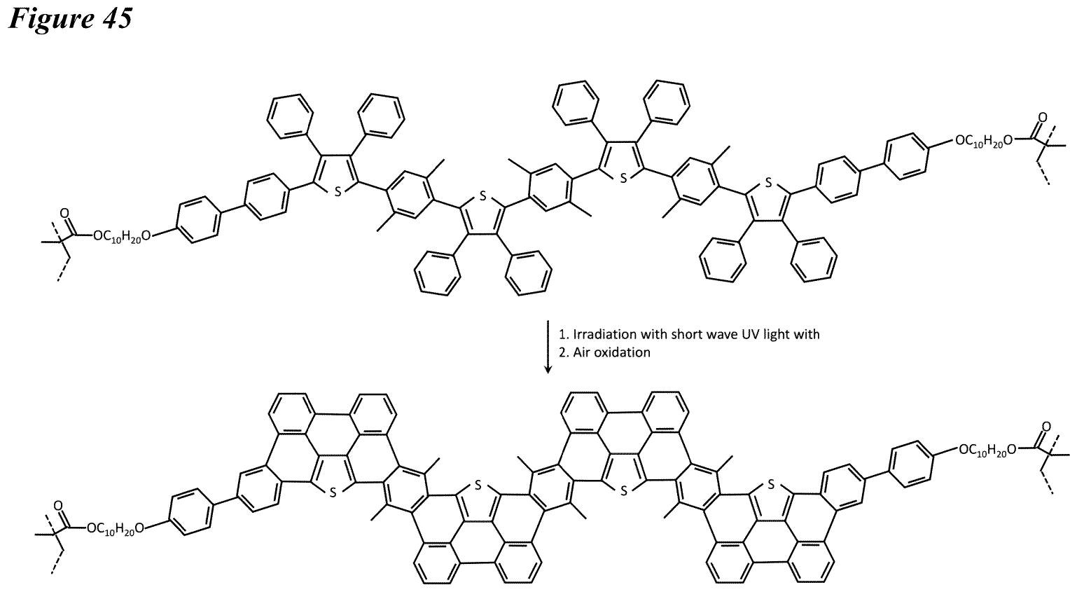

Further embodiments of the invention can yield nematic LC/nanoribbon gel composite materials that comprise heterocyclic ring structures. An example is shown in FIGS. 39 through 45.

Because photochemically induced ring closure reactions are used in the embodiments of this invention, reactants may not need to be intercalated into the composite films containing precursors in order to initiate ring closure reactions. This suggests other embodiments of the invention. A mixture of the photocrosslinkable nanoribbon precursor material and one or more photocrosslinkable nematic materials (reactive mesogens) may be dissolved in a coating solvent and coated down onto a substrate yielding a nematic film. This film may then be photocrosslinked by long wave UV/visible light exposure in the presence of a UV/visible photoinitiator. The precursor material in the polymer film may then be photo-ring-closed using shortwave UV light to yield a nanoribbon composite film. Alternatively, the crosslinking reaction and the ring closure may be accomplished with a single short wave UV exposure.

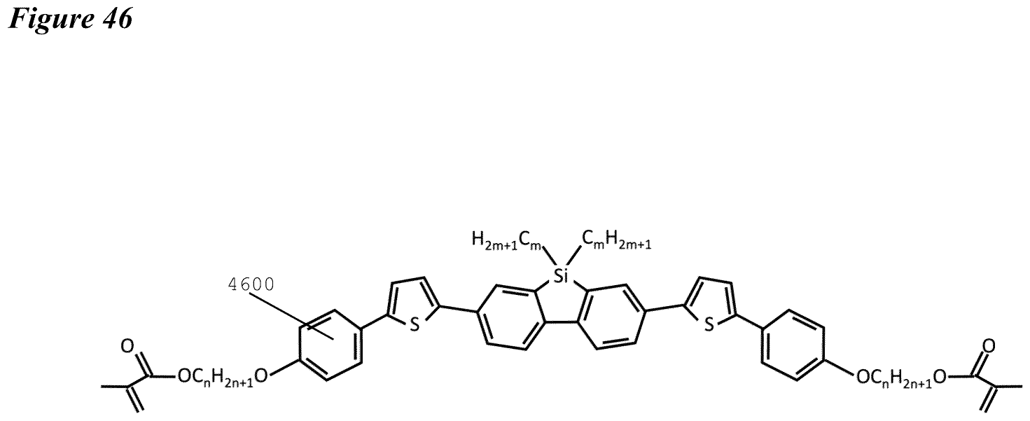

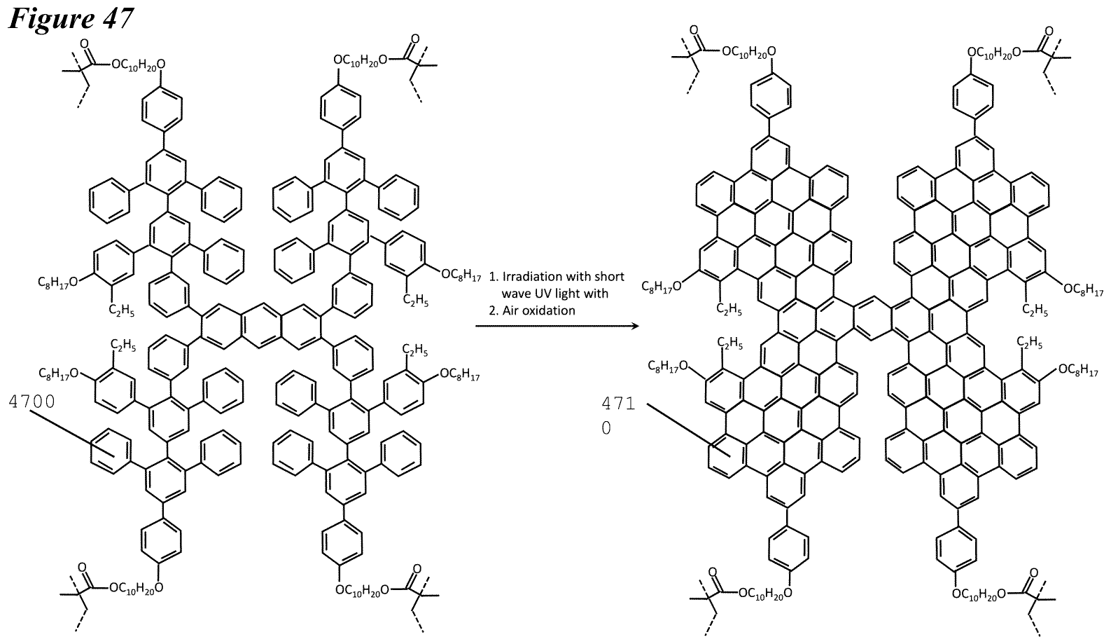

For example, precursor compound 3400 may be mixed with a mixture of liquid crystal isomers having the formula 4600 (FIG. 46) with varying values of m and n.

More disk-shaped, square, or rectangular graphene platelet precursors may be used to produce aerogels or gel composites. For instance, precursor material 4700 may be built up by a series of Suzuki arylation reactions, derivatized with four crosslinking groups. Precursor 4700 may then be mixed in 10% to 40% concentrations with a non-crosslinkable nematic discotic host material such as a mixture of esters of 2,3,6,7,10,11-hexahydroxytriphenylene hexacarboxylic acid containing, for instance, the propionate, butanoate, and pentanoate esters. The nematic discotic mixture is then coated onto a substrate from a deposition solvent in a manner similar to step 1 in the fabrication sequence above. The fabrication steps analogous to steps 2 through 5 above are carried out. The result is the formation of an aerogel containing platelet structural units 4710. A second organic semiconductor material, that may itself have nematic discotic order, may then be intercalated into the aerogel and if that second material is photocrosslinkable, it may be photocrosslinked.

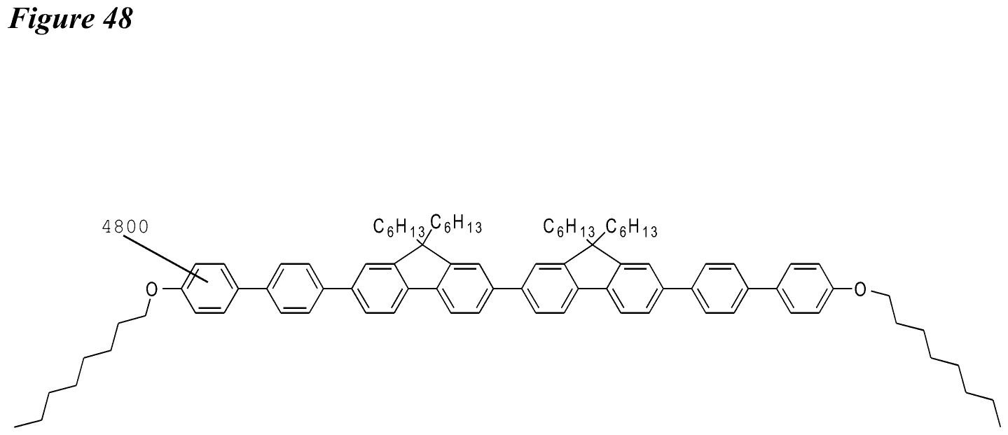

In another embodiment of the invention, a gel-spun fiber may be produced that comprises one or more graphene nanoribbons such as polymers 1400, 2200, 2300, 2600 or 3000. The gel-spinning may be accomplished by utilizing a nematic liquid crystalline fluid solvent. This process requires spinning fiber from a solution of the proper precursor oligomers that were used to fabricate these polymers above, for instance, oligomers 2700 for the fabrication of a fiber comprising polymer 1400. It may be desired to have the values of n in oligomers 2700 or the equivalent polymer to be large numbers so as to maximize the fiber strength and/or electrical conductivity. This may in turn impact the solubility of the oligomer or polymer in the non-crosslinkable liquid crystalline host solvent. The solution to this problem may be to employ a higher molecular weight host with a higher nematic to isotropic transition temperature. Spinning can then be carried out at an elevated temperature maximizing solubility. An example of such a host is material 4800 (FIG. 48).

This compound has a crystal to nematic transition temperature of 147° C. and a nematic to isotropic transition temperature of 250° C. allowing the liquid crystalline solution to be spun at temperatures in excess of 200° C. At these temperatures the solubilities of materials like oligomers 1400 will be increased. In addition, the liquid crystalline solvent will force nematic order on the dissolved photocrosslinkable material. If the geometry of the spinneret of the gel-spinning apparatus induces laminar flow in the extruded polymer solution, the highly anisotropic elastic constants of the liquid crystalline solution that is being spun will insure that the long molecular axes of the solvent liquid crystal's molecules and the dissolved crosslinkable oligomer or polymer molecules will be parallel to the long axis of the spun fiber.

An additional advantage of solvent materials like material 4800 is that they may be glasses at room temperature. This will yield a gel-fiber that has some mechanical stability even before the crosslinking of the dissolved material occurs, thus allowing the fiber to maintain its shape through the crosslinking process. For example, material 4800 has a glass transition temperature of 60° C. and even though the crystalline melting point of material 4800 is 147° C. due to its highly viscous nature when the material is rapidly supercooled to a temperature below 60° C. the liquid crystalline glass material is formed locking in the liquid crystalline structure. It may be desirable to use a mixture of homologous materials having the same aromatic molecular core as material 4800, but with alkyl chains of different lengths replacing the octyl end chains and the hexyl side chains. This would yield a liquid crystalline solvent with a considerably reduced melting point range and a considerably higher tendancy to supercool.

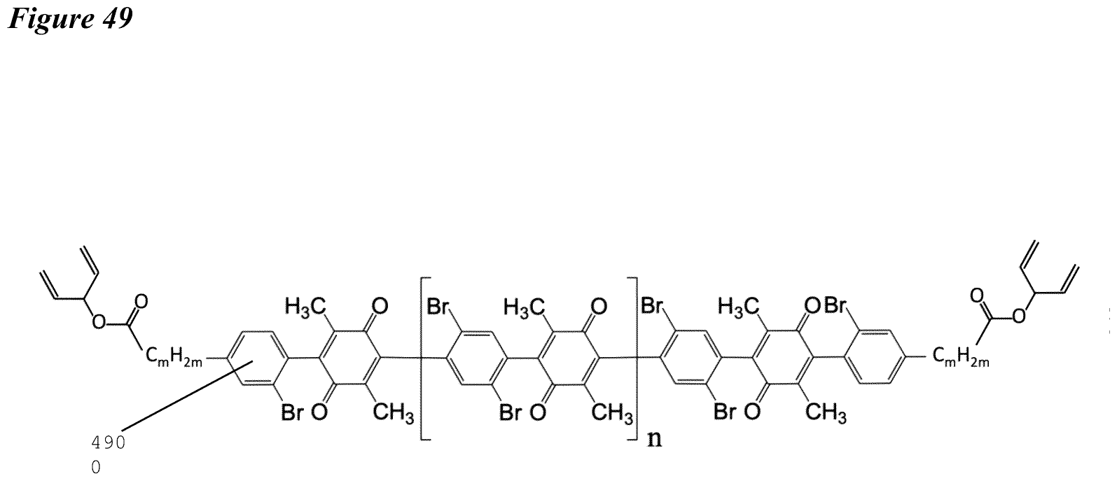

An issue with the use of methacrylate derivatized oligomers or polymers (e.g., oligomers 1400) is that methacrylate monomers thermally polymerize at the elevated temperatures that might be used for the gel spinning discussed here. The methacrylate groups need to be replaced with more thermally stable crosslinking groups. An example of such a crosslinking group is the 1,4-pentadien-3-yl group. The equivalents of oligomers 1400 having this substitution are compounds 4900 (FIG. 49).

Materials derivatized with 1,4-pentadien-3-yl groups may be crosslinked by exposure to laser radiation having a wavelength of approximately 350 nm.

An example of the fabrication process of a fiber from oligomers 4900 is as follows:
1. Material 4800 and its homologues with hexyl, heptyl and decyl end chains are mixed together with oligomers 4900 components having n=4 and m=7, 8, 10, and 11. The combined concentration of the four oligomers 4900 materials in the non-crosslinkable material solvent is 20%.
2. The mixture is heated until all of the oligomers 4900 material has dissolved in the liquid crystalline solvent. The mixing and melting steps and the subsequent steps up through the ring closure step producing the ladder oligomer molecular units are all carried out under a nitrogen blanket to avoid air oxidation of the hydroquinone ring systems in oligomers 4900.
3. The nematic solution is then extruded through a spinneret. The thin strands of extruded material rapidly cool yielding an organic glass fiber.
4. The fiber is irradiated by a HeCd laser at 325 nm. crosslinking the oligomers 4900 material.
5. The fiber is extracted with a boiling toluene solution yielding the desired aerogel fiber.
6. The aerogel fiber is immersed in a toluene solution of catalytic Pd(OAc)₂, catalytic tBuXPhos and DBU that ring closes the furan rings in the polymer backbone.
7. The fiber is rinsed with toluene to remove excess reactants and then dried.

The fiber from step 7 above may be used as is or solvent soluble photocrosslinkable organic semiconductor monomers may be intercalated into the fiber followed by a second crosslinking step.

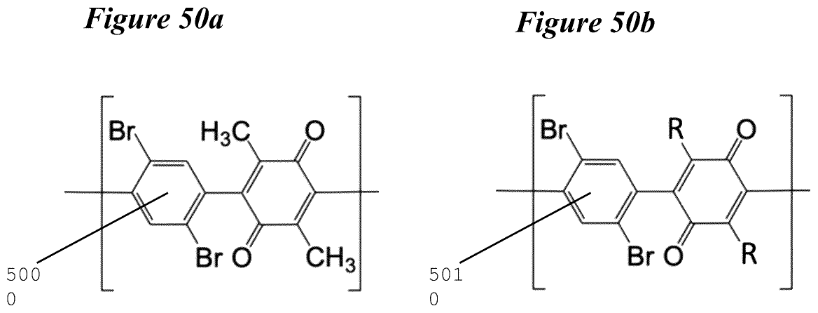

The crosslinkable oligomers or polymers like oligomers 2700 and 4900 may not be sufficiently soluble in the liquid crystalline solvent used in the fiber spinning process. This issue may be solved by substituting longer lateral, flexible sidechains onto the monomer or polymer repeat units. For instance, one or more the repeat units 5000 (FIG. 50a) in oligomers 2700 and 4900 may be replaced with repeat units 5010 (FIG. 50b), where R is a flexible sidechain, for instance, a straight chain or branched alkyl group.

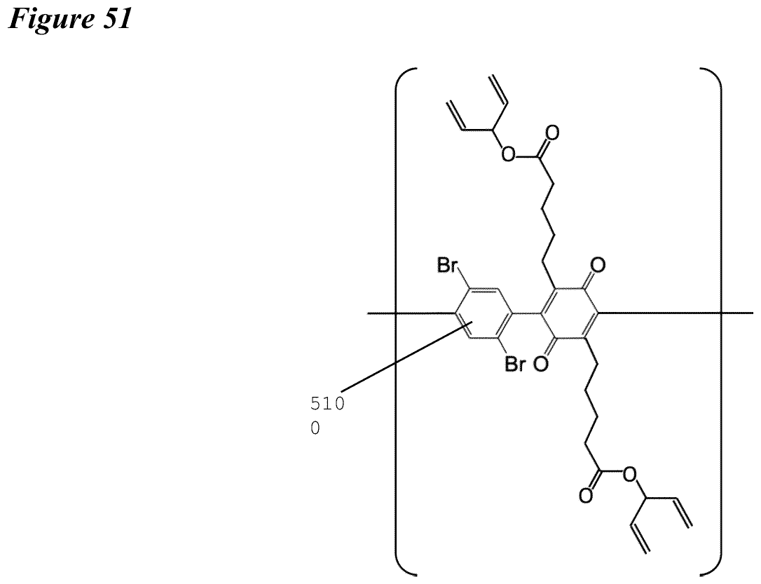

In cases where further crosslinking between the nanoribbon units in the fiber is desirable, these sidechains may be terminated with crosslinking groups. For instance, the replacement repeat unit may have structure 5100 (FIG. 51).

The use of photocrosslinkable oligomers and polymers as precursors to the gel spun fibers is preferred, but other methods of forming crosslinks such as crosslinking generated by alternate forms of radiation or thermal crosslinking may also be used.

In a process analogous to the process for gel spinning nanoribbon polymer containing fibers described above, free-standing graphene nanoplatelet sheet material may be fabricated by extruding a solution of disk-shaped oligomers, such as were described in the synthesis of polymer 4710 above, in a non-crosslinkable nematic discotic host material, as was also described above, through a slit-shaped die and then carrying out similar photocuring and ring closing synthetic steps.

A method according to the present disclosure may be understood in terms of the following processes:

A method of producing an aerogel film comprising polycyclic aromatic structural segments may comprise the following steps:
1. A precursor material comprising a multiplicity of aromatic rings or aromatic ring systems connected by single bonds that allow free rotation between adjacent aromatic rings or aromatic ring systems is mixed in a nematic liquid crystalline material, wherein
because of the length to width aspect ratio of the precursor material molecules they adopt nematic orientational order when dissolved in the nematic liquid crystalline material in its nematic state.
2. The mixture of step 1 is dissolved in a coating solvent.
3. The coating solvent solution of nematic material is solvent cast as a film on a substrate and dried leaving a nematic film.
4. The precursor material is functionalized such that its molecules can crosslink with themselves forming a polymer matrix and the film from step 3 is crosslinked by exposure to long wave ultraviolet or visible light, and wherein the nematic liquid crystalline material into which the precursor was mixed does not crosslink.
5. Optionally the non-crosslinked nematic material is washed out of the film with solvent.
6. The precursor material is exposed to short wave ultraviolet light, wherein this exposure causes chemical bonds to be formed between the rings that were previously only single bonded together with the result that an array of fused aromatic rings is formed across the width and length of the precursor molecules.
7. If the non-crosslinked nematic material was not washed out of the film in step 5, it is washed out now.
8. The resultant aerogel film is dried.
9. A method for producing a composite film in accordance with the preceding steps may further include that the aerogel film has material intercalated into the interstitial volume of the film.

1. An aerogel film comprising graphene nanoribbon segments, wherein:
the graphene nanoribbon segments are crosslinked together at the ends of the graphene nanoribbon segments, wherein:
the graphene nanoribbon segments comprise a molecular backbone of aromatic rings or fused aromatic ring systems concatenated together in an approximately linear fashion along a long axis, and wherein:
the aromatic rings or fused aromatic ring systems in the molecular backbone comprised by the graphene nanoribbon segments are further fused together by bridges of atoms connecting adjacent aromatic rings or fused aromatic ring systems.

2. The aerogel film of claim 1 wherein the long axes of the graphene nanoribbon segments are aligned in approximately the same direction.

3.-6. (canceled)

7. The aerogel film of claim 1 wherein the bridges of atoms connecting the adjacent aromatic rings or fused aromatic ring systems comprise two atoms, each bridge forming a six-membered ring that is fused to the adjacent aromatic rings or fused aromatic ring systems.

8. The aerogel film of claim 7 wherein each six-membered ring that is fused to the adjacent aromatic rings or fused aromatic ring systems is a benzene ring.

9. The aerogel film of claim 1 wherein a first portion of the bridges of atoms connecting the adjacent aromatic rings or fused aromatic ring systems comprise only a single atom forming a five-membered ring that is fused to the adjacent aromatic rings or fused aromatic ring systems and a second portion of the bridges of atoms connecting the adjacent aromatic rings or fused aromatic ring systems comprise two atoms forming a six-membered ring that is fused to the adjacent aromatic rings or fused aromatic ring systems.

10. The aerogel film of claim 1 wherein the graphene nanoribbon segments comprise a helical structure.

11. A composite film comprising graphene nanoribbon segments, wherein the graphene nanoribbon segments are crosslinked together at the ends of the graphene nanoribbon segments, wherein:
the graphene nanoribbon segments comprise a molecular backbone of aromatic rings or fused aromatic systems concatenated together in an approximately linear fashion, wherein:
the aromatic rings or fused aromatic ring systems in the molecular backbone comprised by the graphene nanoribbon segments are further fused together by bridges of atoms connecting adjacent aromatic rings or fused aromatic ring systems, and wherein;
the graphene nanoribbon segments are embedded in a matrix material.

12. The composite film of claim 11 wherein the matrix material has a liquid crystalline structure.

13. The composite film of claim 11 wherein the matrix material is a polymer.

14. (canceled)

15. The composite film of claim 11 wherein the matrix material is an electric charge transporting material.

16. The composite film of claim 11 wherein the interface between the crosslinked graphene nanoribbon segments and the matrix material forms a p-n junction.

17. The composite film of claim 11 wherein the bridges of atoms connecting the adjacent aromatic rings or fused aromatic ring systems comprise only a single atom forming a five-membered ring that is fused to the adjacent aromatic rings or fused aromatic ring systems.

18. The composite film of claim 17 wherein the five-membered rings that are fused to the adjacent aromatic rings or fused aromatic ring systems contain a sulfur atom.

19. The composite film of claim 17 wherein the five-membered rings that are fused to the adjacent aromatic rings or fused aromatic ring systems contain an oxygen atom.

20. The composite film of claim 17 wherein the five-membered rings that are fused to the adjacent aromatic rings or fused aromatic ring systems contain a nitrogen atom.

21. The composite film of claim 11 wherein the bridges of atoms connecting the adjacent aromatic rings or fused aromatic ring systems comprise two atoms forming a six-membered ring that is fused to the adjacent aromatic rings or fused aromatic ring systems.

22. The composite film of claim 21 wherein the six-membered ring that is fused to the adjacent aromatic rings or fused aromatic ring systems is a benzene ring.

23.-50. (canceled)

51. A gel-spun fiber comprising graphene nanoribbon polymer segments, wherein:
the graphene nanoribbon polymer segments are crosslinked together at the ends of the graphene nanoribbon polymer segments, wherein:
the graphene nanoribbon polymer segments comprise a molecular backbone of aromatic rings or fused aromatic systems concatenated together in an approximately linear fashion, and wherein:
the aromatic rings or fused aromatic ring systems in the molecular backbone comprised by the graphene nanoribbon polymer segments are further connected together by bridges of atoms connecting adjacent aromatic rings or fused aromatic ring systems.

52. The gel-spun fiber of claim 51 wherein each of the bridges of atoms connecting the adjacent aromatic rings or fused aromatic ring systems comprise only a single atom forming a five-membered ring that is fused to the adjacent aromatic rings or fused aromatic ring systems.

53. The gel-spun fiber of claim 52 wherein each of the five-membered rings that are fused to the adjacent aromatic rings or fused aromatic ring systems contain a sulfur atom.

54.-89. (canceled)
